(19) United States
(12) Patent Application Publication
(10) Pub. No.: US 2026/0352561 A1
(43) Pub. Date: Nov. 5, 2026

(54) Methods to for Reporting Feedback Related to AI/ML Events

(71) Applicant: Telefonaktiebolaget LM Ericsson (publ), Stockholm (SE)

(72) Inventors: Pablo Soldati, Solna (SE); Luca Lunardi, Genova (IT); Angelo Centonza, Granada (ES); Serban Purge, Issy-Ies-Moulineaux (FR); Germán Bassi, Årsta (SE); Reem Karaki, Aachen (DE); Ioanna Pappa, Stockholm (SE); Philipp Bruhn, Aachen (DE)

(21) Appl. No.: 19/124,169

(22) PCT Filed: Nov. 3, 2023
(86) PCT No.: PCT/EP2023/080703

§ 371 Date: Apr. 24, 2025

Related U.S. Application Data
(60) Provisional application No. 63/422,266, filed on Nov. 3, 2022.

(30) Foreign Application Priority Data
Jan. 16, 2023 (GR) 20230100026

(51) Int. Cl. H04L 41/16; H04L 41/0816

(52) U.S. Cl. CPC H04L 41/16; H04L 41/0816

(57) ABSTRACT

A framework is defined for measuring and reporting information related to Artificial Intelligence (AI)/Machine Learning (ML) in a wireless communication network. An event configuration is generated, comprising an event definition configuration defining one or more AI/ML events, and including one or more identifiers, parameters, indications, actions, or conditions by which a second network node determines whether the AI/ML events are fulfilled, and an event reporting configuration defining the content and structure of a report of an event, to be generated and sent by the second network node upon fulfillment of the AI/ML event(s). An event configuration identifier is associated with the event configuration. In one aspect, an AI/ML event is an ML model action instance or action type.

### TECHNICAL FIELD

The present disclosure relates generally to wireless communication networks, and in particular to Artificial Intelligence/Machine Learning related event reporting.

### BACKGROUND

Embodiments of the present invention relate generally to wireless communication networks, and in particular to network signaling for providing feedback, particularly related to the use of Artificial Intelligence/Machine Learning (AI/ML), between network nodes in wireless communication networks.

FIG. 1 depicts the Next Generation (NG) Radio Access Network (RAN), which consists of a set of gNBs connected to the 5th Generation Core (5GC) through the NG interface.

NOTE: As specified in 3GPP TS 38.300, NG-RAN could also consist of a set of ng-eNBs, an ng-eNB may consist of an ng-eNB-CU and one or more ng-eNB-DU(s). An ng-eNB-CU and an ng-eNB-DU are connected via W1 interface. The general principle described in this section also applies to ng-eNB and W1 interface, if not explicitly specified otherwise.

A gNB can support FDD mode, TDD mode or dual mode operation.

gNBs can be interconnected through the Xn interface.

A gNB may consist of a gNB-CU and one or more gNB-DU(s). A gNB-CU and a gNB-DU are connected via F1 interface.

One gNB-DU is connected to only one gNB-CU.

NOTE: In case of network sharing with multiple cell ID broadcast, each Cell Identity associated with a subset of PLMNs corresponds to a gNB-DU and the gNB-CU it is connected to, i.e., the corresponding gNB-DUs share the same physical layer cell resources.

NOTE: For resiliency, a gNB-DU may be connected to multiple gNB-CUs by appropriate implementation.

NG, Xn and F1 are logical interfaces.

For NG-RAN, the NG and Xn-C interfaces for a gNB consisting of a gNB-CU and gNB-DUs, terminate in the gNB-CU. For EN-DC, the S1-U and X2-C interfaces for a gNB consisting of a gNB-CU and gNB-DUs, terminate in the gNB-CU. The gNB-CU and connected gNB-DUs are only visible to other gNBs and the 5GC as a gNB. A possible deployment scenario is described in Annex A.

The node hosting user plane part of NR PDCP (e.g., gNB-CU, gNB-CU-UP, and for EN-DC, MeNB or SgNB depending on the bearer split) shall perform user inactivity monitoring and further informs its inactivity or (re) activation to the node having C-plane connection towards the core network (e.g., over E1, X2). The node hosting NR RLC (e.g., gNB-DU) may perform user inactivity monitoring and further inform its inactivity or (re) activation to the node hosting control plane, e.g., gNB-CU or gNB-CU-CP.

UL PDCP configuration (i.e. how the UE uses the UL at the assisting node) is indicated via X2-C (for EN-DC), Xn-C (for NG-RAN) and F1-C. Radio Link Outage/Resume for DL and/or UL is indicated via X2-U (for EN-DC), Xn-U (for NG-RAN) and F1-U.

The NG-RAN is layered into a Radio Network Layer (RNL) and a Transport Network Layer (TNL).

The NG-RAN architecture, i.e. the NG-RAN logical nodes and interfaces between them, is defined as part of the RNL.

For each NG-RAN interface (NG, Xn, F1) the related TNL protocol and the functionality are specified. The TNL provides services for user plane transport, signaling transport.

In NG-Flex configuration, each NG-RAN node is connected to all AMFs of AMF Sets within an AMF Region supporting at least one slice also supported by the NG-RAN node. The AMF Set and the AMF Region are defined in 3GPP TS 23.501.

If security protection for control plane and user plane data on TNL of NG-RAN interfaces is supported, NDS/IP 3GPP TS 33.501 shall be applied.

The overall architecture for separation of gNB-CU-CP and gNB-CU-UP is depicted in FIG. 2 and specified in 3GPP TS 37.483.
A gNB may consist of a gNB-CU-CP, multiple gNB-CU-UPs and multiple gNB-DUs;
The gNB-CU-CP is connected to the gNB-DU through the F1-C interface;
The gNB-CU-UP is connected to the gNB-DU through the F1-U interface;
The gNB-CU-UP is connected to the gNB-CU-CP through the E1 interface;
One gNB-DU is connected to only one gNB-CU-CP;
One gNB-CU-UP is connected to only one gNB-CU-CP;
NOTE 1: For resiliency, a gNB-DU and/or a gNB-CU-UP may be connected to multiple gNB-CU-CPs by appropriate implementation.
One gNB-DU can be connected to multiple gNB-CU-UPs under the control of the same gNB-CU-CP;
One gNB-CU-UP can be connected to multiple DUs under the control of the same gNB-CU-CP;
NOTE 2: The connectivity between a gNB-CU-UP and a gNB-DU is established by the gNB-CU-CP using Bearer Context Management functions.
NOTE 3: The gNB-CU-CP selects the appropriate gNB-CU-UP(s) for the requested services for the UE. In case of multiple CU-UPs they belong to same security domain as defined in 3GPP TS 33.210.
NOTE 4: Data forwarding between gNB-CU-UPs during intra-gNB-CU-CP handover within a gNB may be supported by Xn-U.

3GPP TR 37.817 provides descriptions of principles for RAN intelligence enabled by AI, a functional framework (depicted in FIG. 3, outlining AI functionality as well as inputs and outputs for AI enabled optimization) as well as use cases and solutions of AI enabled RAN. The study is based on the current architecture and interfaces. The analyzed use cases are Network Energy Saving, Load Balancing, and Mobility Optimization, and for all those AI/ML Model Training is located either in the OAM or in the gNB, specifically gNB-CU. FIG. 4, FIG. 5, and FIG. 6 each depict the case where Model Training is located in the OAM for the three use cases. Note that AI/ML Model Inference is always located in the NG-RAN.

3GPP TR 37.817 mentions the use of “Feedback”. Section 4.2 of TR 37.817 states: Actor is a function that receives the output from the Model Inference function and triggers or performs corresponding actions. The Actor may trigger actions directed to other entities or to itself.

Feedback: Information that may be needed to derive training data, inference data or to monitor the performance of the AI/ML Model and its impact to the network through updating of KPIs and performance counters.

As described below, NG-RAN node 1, which hosts the Model Inference, and NG-RAN node 2, which is any neighboring NG-RAN node of NG-RAN node 1, both provide feedback related to the Network Energy Saving, Load Balancing, or Mobility Optimization action taken by NG-RAN node 1 to the OAM. Section 5.1.2.6, Section 5.2.2.6, and Section 5.3.2.6 in TR 37.817 list the type of feedback given for AI/ML-based Network Energy Saving, Load Balancing, and Mobility Optimization. In one example, the action taken by NG-RAN node 1 (serving NG-RAN node) entails a handover of at least one UE to NG-RAN node 2 (target NG-RAN node). In this example, the feedback (in this case provided to the OAM) includes UE performance (e.g., of handed-over UEs), affected by the action, including QoS parameters such throughput/bitrate, packet delay/latency, packet loss, etc. Additional details can be found in TR 37.817.

Section 5.1.2.2 of TR 37.817 for the Network Energy Saving Use Case States, with Reference to FIG. 5.1.2.1-1 (Reproduced Herein as FIG. 4):

### AI/ML Model Training at OAM and AI/ML Model Inference at NG-RAN

In this solution, NG-RAN makes energy decisions using AI/ML model trained from OAM.
Step 0: NG-RAN node 2 is assumed to have an AI/ML model optionally, which can provide NG-RAN node 1 with input information.
Step 1: NG-RAN node 1 configures the measurement information on the UE side and sends configuration message to UE to perform measurement procedure and reporting.
Step 2: The UE collects the indicated measurement(s), e.g., UE measurements related to RSRP, RSRQ, SINR of serving cell and neighbouring cells.
Step 3: The UE sends the measurement report message(s) to NG-RAN node 1.
Step 4: NG-RAN node 1 further sends UE measurement reports together with other input data for Model Training to OAM.
Step 5: NG-RAN node 2 (assumed to have an AI/ML model optionally) also sends input data for Model Training to OAM.
Step 6: Model Training at OAM. Required measurements and input data from other NG-RAN nodes are leveraged to train AI/ML models for network energy saving.
Step 7: OAM deploys/updates AI/ML model into the NG-RAN node(s). The NG-RAN node can also continue model training based on the received AI/ML model from OAM.
Note: This step is out of RAN3 Rel-17 scope.
Step 8: NG-RAN node 2 sends the required input data to NG-RAN node 1 for model inference of AI/ML-based network energy saving.
Step 9: UE sends the UE measurement report(s) to NG-RAN node 1.
Step 10: Based on local inputs of NG-RAN node 1 and received inputs from NG-RAN node 2, NG-RAN node 1 generates model inference output(s) (e.g., energy saving strategy, handover strategy, etc).
Step 11: NG-RAN node 1 sends Model Performance Feedback to OAM if applicable.
Note: This step is out of RAN3 scope.
Step 12: NG-RAN node 1 executes Network energy saving actions according to the model inference output. NG-RAN node 1 may select the most appropriate target cell for each UE before it performs handover, if the output is handover strategy.
Step 13: NG-RAN node 2 provides feedback to OAM.
Step 14: NG-RAN node 1 provides feedback to OAM.

### Section 5.1.2.6 of TR 37.817 for the Network Energy Saving Use Case States:

Feedback of AI/ML-based Network Energy Saving To optimize the performance of an AI/ML-based network energy saving model, the following feedback can be considered to be collected from NG-RAN nodes:
Resource status of neighboring NG-RAN node/s
Energy efficiency
UE performance affected by the energy saving action (e.g., handed-over UEs), including bitrate, packet loss and latency
System KPIs (e.g., throughput, delay, Radio Link Failure (RLF) of current and neighboring NG-RAN node).
   Section 5.2.2.2 of TR 37.817 for the Load Balancing Use Case States, with Reference to FIG. 5.2.2.1-1 (Reproduced Herein as FIG. 5):

### AI/ML Model Training in OAM and AI/ML Model Inference in a NG-RAN Node

Step 0: NG-RAN node 2 is assumed to have an AI/ML model optionally, which can provide NG-RAN node 1 with useful input information, such as predicted resource status, etc.
Step 1: The NG-RAN node 1 configures the UE to provide measurements and/or location information (e.g., RRM measurements, MDT measurements, velocity, position).
Step 2: The UE collects the indicated measurement(s), e.g., UE measurements related to RSRP, RSRQ, SINR of serving cell and neighbouring cells.
Step 3: The UE reports to NG-RAN node 1 requested measurements and/or location information (e.g., UE measurements related to RSRP, RSRQ, SINR of serving cell and neighbouring cells, velocity, position).
Step 4: NG-RAN node 1 further sends UE measurement reports together with other input data for Model Training to OAM. NG-RAN node 2 also sends input data for Model Training to OAM.
Step 5: AI/ML Model Training is located at OAM. The required measurements and input data from other NG-RAN nodes are leveraged to train the AI/ML model.
Step 6: OAM deploys/updates AI/ML model into the NG-RAN node(s). The NG-RAN node is allowed to continue model training based on the received AI/ML model from OAM.
Note: This step is out of RAN3 Rel-17 scope.
Step 7: The UE collects and reports to NG-RAN node 1 requested measurements or location information.
Step 8: The NG-RAN node 1 receives from the neighboring NG-RAN node 2 the input information for load balancing model inference.
Step 9: NG-RAN node 1 performs model inference and generates Load Balancing predictions or decisions.
Step 10. The NG-RAN 1 sends the model performance feedback to OAM if applicable.
Note: This step is out of RAN3 scope.
Step 11: NG-RAN node 1 may take Load Balancing actions and the UE is moved from NG-RAN node 1 to NG-RAN node 2.
Step 12: NG-RAN node 1 and NG-RAN node 2 send feedback information to OAM.

### Section 5.2.2.6 of TR 37.817 for the Load Balancing Use Case States:

### Feedback of AI/ML-Based Load Balancing.

To optimize the performance of an AI/ML-based load balancing model, the following feedback can be considered to be collected from NG-RAN nodes:
UE performance information from target NG-RAN node (for those UEs handed over from source NG-RAN node)
Resource status information updates from target NG-RAN node
System KPIs (e.g., throughput, delay, RLF of current and neighboring NG-RAN node/s).

Section 5.3.2.2 of TR 37.817 for the Mobility Optimization use case states, with reference to FIG. 5.3.2.1-1 (reproduced herein as FIG. 6):

### AI/ML Model Training in OAM and AI/ML Model Inference in NG-RAN Node

Step 0. NG-RAN node 2 is assumed to optionally have an AI/ML model, which can generate required input such as resource status and utilization prediction/estimation etc.
Step 1. The NG-RAN node configures the measurement information on the UE side and sends configuration message to UE including configuration information.
Step 2. The UE collects the indicated measurement, e.g., UE measurements related to RSRP, RSRQ, SINR of serving cell and neighbouring cells.
Step 3. The UE sends measurement report message to NG-RAN node 1 including the required measurement.
Step 4. The NG-RAN node 1 sends the input data for training to OAM, where the input data for training includes the required input information from the NG-RAN node 1 and the measurement from UE.
Step 5. The NG-RAN node 2 sends the input data for training to OAM, where the input data for training includes the required input information from the NG-RAN node 2. If the NG-RAN node 2 executes the AI/ML model, the input data for training can include the corresponding inference result from the NG-RAN node 2.
Step 6. Model Training. Required measurements are leveraged to training AI/ML model for UE mobility optimization.
Step 7. OAM sends AI/ML Model Deployment Message to deploy the trained/updated AI/ML model into the NG-RAN node(s). The NG-RAN node can also continue model training based on the received AI/ML model from OAM.
Note: This step is out of RAN3 Rel-17 scope.
Step 8. The NG-RAN node 1 obtains the measurement report as inference data for UE mobility optimization.
Step 9. The NG-RAN node 1 obtains the input data for inference from the NG-RAN node 2 for UE mobility optimization, where the input data for inference includes the required input information from the NG-RAN node 2. If the NG-RAN node 2 executes the AI/ML model, the input data for inference can include the corresponding inference result from the NG-RAN node 2.
Step 10. Model Inference. Required measurements are leveraged into Model Inference to output the prediction, e.g., UE trajectory prediction, target cell prediction, target NG-RAN node prediction, etc.
Step 11. The NG-RAN 1 sends the model performance feedback to OAM if applicable.
Note: This step is out of RAN3 scope.
Step 12: According to the prediction, recommended actions or configuration, the NG-RAN node 1, the target NG-RAN node (represented by NG-RAN node 2 of this step in the flowchart), and UE perform the Mobility Optimization/handover procedure to hand over UE from NG-RAN node 1 to the target NG-RAN node.
Step 13. The NG-RAN node 1 sends the feedback information to OAM.
Step 14. The NG-RAN node 2 sends the feedback information to OAM.

### Section 5.3.2.6 of TR 37.817 for the Mobility Optimization Use Case States:

### Feedback of AI/ML-Based Mobility Optimization

To optimize the performance of an AI/ML-based mobility optimization model, the following data is required as feedback data:
QoS parameters such as throughput, packet delay, etc. of handed-over UE
Resource status information updates from target NG-RAN node
Performance information from target NG-RAN node
   The details of the performance information are to be discussed during normative work phase.

As stated above, 3GPP TR 37.817 also studies the case where both the AI/ML Model Training and the AI/ML Model Inference are located at NG-RAN (i.e., gNB). In this case, the feedback is signaled from NG-RAN node 2 to the NG-RAN node 1 hosting the Model Training and Model Inference function but is the same as described above.

3GPP TR 37.817 also mentions the use of so-called “Model Performance Feedback”. Section 4.2 of 3GPP TR 37.817 states:
Model Inference is a function that provides AI/ML model inference output (e.g., predictions or decisions). Model Inference function may provide Model Performance Feedback to Model Training function when applicable. The Model Inference function is also responsible for data preparation (e.g., data pre-processing and cleaning, formatting, and transformation) based on Inference Data delivered by a Data Collection function, if required.
   Output: The inference output of the AI/ML model produced by a Model Inference function.
      Note: Details of inference output are use case specific.
   Model Performance Feedback: It may be used for monitoring the performance of the AI/ML model, when available.
      Note: Details of the Model Performance Feedback process are out of RAN3 scope.

As can be seen from 3GPP TR 37.817, the Model Performance Feedback is intended to provide an indication of the performance of the AI/ML model, but it has not been defined yet.

Feedback information associated to AI/ML model inference, such as for prediction of certain information, or for control actions derived by or with an AI/ML model, such as user mobility actions (i.e., handover from a cell of a source node to a cell of a target node), may require collecting and/or combining multiple measurements. However, in certain circumstances such measurements may not be readily available or may be available later when they are no longer relevant as feedback associated to an AI/ML model inference or for a control action determined by or with an AI/ML model or algorithm.

Considering the example of feedback information related to UE handover due to mobility, the source node may request the target node to provide feedback information associated to one or more feedback metrics, such as throughput, latency, packet error rate, QoE, QoS, etc., experienced by the user device once it is handed over. The feedback information may be requested to be provided periodically or in one shot (e.g., event triggered, or upon a measuring window of time). However, the availability of samples of feedback information at the target node depends on many factors, such as the presence of traffic for the UE, the availability of radio resources to serve the UE, etc., which may not make the feedback available in a timely manner or only after too much time has passed, which would make the correlation to the handover action no longer relevant.

Therefore, it is possible that either samples of the requested feedback information are not available for the UE handed over (e.g., if the UE has no traffic), or the samples may be available at a later time when they no longer represent a suitable feedback in relation to the AI/ML action to which it is associated (e.g., if the feedback is supposed to indicate whether the handover decision is correct or not).

An additional problem with existing or published technology using periodic feedback for AI/ML models or algorithms is the termination of the reporting of feedback information when such feedback is either not present or no longer needed.

Another problem in existing technology is that feedback may be requested for an action that is initialized or executed with a legacy signaling procedure between two network nodes, typically associated to a specific use case to which the action is relevant (e.g., mobility handover preparation procedure for handover events), while the requested feedback may need to be provided with a second procedure that is use case agnostic. Existing art does not provide solutions to handle a request for feedback provided with a use case specific procedure and the delivery of the requested information being handled with a second, possibly use case agnostic, procedure.

### Ongoing 3GPP Discussion

As per 3GPP discussions in RAN3 concerning the support of AI/ML in NG-RAN, a working assumption (WA) has been reached according to which “Procedures used for AI/ML support in the NG-RAN shall be “data type agnostic””. The following two options were discussed, as captured in R3-226884:
Option 1: Introduce a new separate procedure for various information, e.g., input and feedback.
Pros from proponent companies:
The separated procedure could be leveraged for different triggered action, which can help the receiving node distinguish whether the information is used as input data or feedback data.
Moreover, if particular feedback information is identified in the future, new separate procedure can be future-proof. However, the single “data agnostic” procedure will lead to misunderstanding, which mix all AI/ML related information in one procedure.
Option 2: Use a single “data agnostic” procedure to transfer the various information,
Pros from proponent companies:
AI/ML information can be used as either input, output, or feedback information. Then, signalling such information in a dedicated procedure would lead to duplication of information signalling over different procedures, and the requesting node knows what use it will make of such predictions independently of the procedure that reports them. Moreover, splitting the information signalling in multiple procedures is subject to following drawbacks:
   An Inference function that uses both what is called “input” and what is called “feedback” as inputs to derive inference needs to wait for multiple messages to arrive before inference can be carried out. Namely, inputs to inference are out of synch and may not even be collected at the same time.
   There is an unnecessary implementation limitation in 3GPP specifications, where some information is defined as e.g. feedback, or input. One of the main agreements at the basis of AI/ML work is that AI/ML algorithms are implementation specific, hence an algorithm shall not be forced to use a specific piece of information e.g. as feedback

One of the points left to be clarified is how to make a generic procedure flexible enough to accommodate the need for various reporting characteristics. In some cases, the network node requesting the reporting is willing to receive reports on a periodic basis. In other cases, the same network node may wish to receive reports upon triggering a certain event. Some requirements of the procedure are identified in the comment posted in a discussion captured in the same document R3-226884:
The source node should be able to select specific types of UE performance feedback from a target that can be a subset of all types of information (throughput or delay but not both for example) and a duration for this average. It should also be able to select a UE or group of UEs for which UE performance feedback is requested. So, procedure needs to allow configuration of UE performance calculation at a target.
Target needs to be able to determine when to send the UE performance feedback to the source. Since UE performance could depend on an event that throughput or delay satisfy procedure shall allow also an event-based reporting.
Our thinking on feedback for UE performance is that it is one shot since feedback is sent as a response to calculate a reward or cost after a single action (a HO) is taken but periodic feedback reporting could be supported.

To support the flexibility requested, initial suggestions on how such requirements could be fulfilled have been identified, as listed below:
Configure periodic reporting for specific metrics (e.g. used as inputs)
Configure event based reporting for specific metrics, e.g. by including the events that will trigger reporting of certain information.
   For such event based reporting we could also specify a “Report Amount” (See MDT, where this is used), namely a number of metric instances to be reported. The metrics could be reported with the period configured for the number of report amount instances
Report the requested metrics as follows:
   Metrics requested periodically are reported every period
   Metrics that are requested on an event based are reported upon occurrence of the event and according to the configuration provided, e.g. for a specific number of instances

The published technology has identified some requirements needed to obtain relevant information to support AI/ML in RAN, in particular the need to collect feedback upon fulfillment of events. However, it is not clearly indicated which events are to be supported (except handover), and how to support them. An exception to the latter relates to indicating a generic need for configuring event-based reporting for specific metrics, and, in the reporting phase, to reuse the same approach valid for Minimization of Drive Test (MDT) measurements, where a number of metric instances is reported.

Therefore, several aspects remain unresolved in relation to how to provide information (e.g., feedback) to support AI/ML in RAN when such information is based on events. Another aspect to clarify is which events, apart from handover, are needed for AI/ML in RAN, their definitions, and the associated reporting.

A particular aspect of events for AI/ML in RAN is that these events may depend on outputs of AI/ML models, which were not considered previously in 3GPP. For example, if the predicted energy consumption of a NG-RAN node suddenly changes, this may be related to changes in the traffic experienced by the NG-RAN, or it may be related to the way the prediction is made. Properly distinguishing these differences may allow the system to better interpret the feedback information obtained from the events.

### SUMMARY

To resolve issues with prior art, aspects of the present disclosure first disclose a method for a first network node to control the feedback reporting associated to an action indicated by the first network node and involving a second network node and/or a user device. This solution is then generalized to a method to control feedback reporting associated to any event, and including configuring the reporting of the event. An action identifier or type is then a particular case of the more general definition of an event.

In the present disclosure, some methods are performed by two network nodes, wherein first network node requests feedback associated to a type of action (or action type) (e.g., a class of actions, such as handover actions) or to a specific action instance (e.g., a certain occurrence of an action of a certain type of action), and the second network node provides the requested feedback. The first network node may request feedback associated to an action type by means of an action type indicator, while it could request feedback associated to a specific instance of an action type Y by means of an action feedback identifier, such as an action-ID. In some cases, an action feedback identifier may indicate (either implicitly or explicitly) both an action type and an identifier of an action instance. The first network node may therefore provide at least a feedback reporting configuration to the second network node associated to either an action type indicator, to an action identifier or both. The second network node reports feedback according to the feedback reporting configuration, and in a way that can be associated to the action type and/or action instance received as part of the feedback reporting configuration.

The identifier of the type of action and the feedback reporting configuration may be signaled in the same or in different signaling procedures.

In one aspect, only one process is used, made of two procedures, one procedure for feedback reporting configuration and one procedure for feedback update. One message of the configuration procedure comprising the request for feedback and a second message of the feedback update procedure comprising the feedback. In this aspect, the first network node transmits a first message comprising the request for feedback associated to a type of action and optionally a first feedback reporting configuration and/or conditions associated to the type of actions. The first network node receives the requested feedback with another message of the same procedure. In this case, action type identifier and the action identifier may be transmitted together, or the action identifier may implicitly indicate an action type. In this case the feedback received by the first network node may either be implicitly associated to the action type and/or action identifier, or the feedback can be received with an explicit indication of the action type and/or action identifier to which the feedback is associated.

In a second aspect, two procedures are used, one of them is specific for AI/ML based/assisted use case and another one is not specific for AI/ML based/assisted use case. The first network node uses one message of the first procedure to request and initialize feedback information reporting associated to a type of action (e.g., by providing an action type identifier), while it may use anther message of a second procedure to request feedback associated to a specific action instance of the indicated action type (e.g., by providing an action identifier), and/or modify the first feedback reporting configuration and/or conditions initialized with the message of the first procedure by means of a second feedback reporting configuration and/or conditions. In this case the first network node receives feedback via a message of the first or second procedure, or alternatively, via a third procedure used to provide feedback updates. The feedback received by the first network node may either be implicitly associated to the action type and/or action identifier received via the first and/or second procedure, or the feedback can be received with an explicit indication of the action type and/or action identifier to which the feedback is associated.

In a third aspect, two procedures are used, and none of them is specific for AI/ML. This aspect follows the same method of the second aspect. The first network node uses one message of the first procedure to request and initialize feedback information reporting associated to a type of action (e.g., by providing an action type identifier), while it may use another message of a second procedure to request feedback associated to a specific action instance of the indicated action type (e.g., by providing an action identifier), and/or modify the first feedback reporting configuration and/or conditions initialized with the message of the first procedure by means of a second feedback reporting configuration and/or conditions. Non-limiting examples of procedures that can be considered include: handover (one procedure for preparation, one procedure for execution/completion), conditional handover (preparation and execution), PSCell Change (preparation and execution), conditional PSCell change (preparation and execution), and Resource Status Reporting. In this case the first network node receives feedback via a message of the first or second procedure, or alternatively, via a third procedure used to provide feedback updates. A non-limiting example of the third procedure is the Xn: Resource Status Update. The feedback received by the first network node may either be implicitly associated to the action type and/or action identifier received via the first and/or second procedure, or the feedback can be received with an explicit indication of the action type and/or action identifier to which the feedback is associated.

In some cases, a cause value can be used as the action identifier for a specific type of action or together with an action identifier for a specific type of action. For example, in the handover case, the action type can be “handover”, or “AI/ML assisted handover” or “AI/ML based handover” and the action identifier could include a cause value (e.g., load balance, energy savings, etc.) and possibly a parameter identifying the context of the UE for which the handover is carried out.

More generally, the present disclosure describes events for AI/ML in RAN and their handling in terms of configuration and reporting.

Events to support AI/ML in RAN have a unique significance. For example, AI/ML related feedback is associated to specific event(s) (e.g., an action/output) determined by an AI/ML inference function), When feedback is signaled, the receiver needs to be able to associate the feedback to the corresponding event(s). So, there is a need for defining events and their handling.

Furthermore, the definition of events for AI/ML in RAN is intrinsically related to the nature of AI/ML processes and algorithms, which are different from legacy rule-based algorithms. The events for AI/ML in RAN may thus be defined according to the AI/ML models that are involved in the events and their behavior.

In one aspect of the present disclosure, an event configuration for an event for AI/ML in RAN is received by a network node (in the aspects, the second network node). An event configuration includes two parts: the event definition configuration and the event reporting configuration.

In one aspect, the complete event configuration is signaled from a first network node to the second network node.

In another aspect, the event configuration is signaled to the second network node partly by the first network node, and partly by a third network node.

In another aspect, the event configuration is assembled by the first network node (and sent to the second network node), based on assistance information provided to the first network node by a third network node.

In all aspects, a framework is defined for handling events (configuration and associated reporting) to be used for collection of information to support AI/ML processes in RAN. Specific aspects of such events are: 1) they relate to outputs (e.g., actions) determined by an AI/ML inference function; 2) conditions upon which such events are fulfilled can relate to parameters/characteristics associated to an output produced by an AI/ML inference function (such as accuracy, validity time, uncertainty). By means of definition of such events, configurations can be carried out towards nodes that would report the required information conditionally to fulfillment of the defined events. Information reporting based on such event-based criteria allows for selected collection of AI/ML related data, that can be used for targeted AI/ML optimization.

One aspect relates to a method, performed by a first network node, of ascertaining information related to AI/ML in a wireless communication network. An event configuration is generated or obtained (e.g., in whole or part from a third node). The event configuration comprises an event definition configuration (EDC) defining one or more AI/ML events, and including one or more identifiers, parameters, indications, actions, or conditions by which a second network node determines whether the AI/ML events are fulfilled. The event configuration further comprises an event reporting configuration (ERC) defining the content and structure of a report of an event, to be generated and sent by the second network node upon fulfillment of the AI/ML event(s), and including information regarding when and where in the network to send the report. An event configuration identifier is associated with the event configuration. At least part of the event configuration and the event configuration identifier are sent to a second network node in a first message.

### BRIEF DESCRIPTION OF THE DRAWINGS

FIG. 1 is a block diagram of the NG-RAN architecture as defined in 3GPP TS 38.401.

FIG. 2 is a block diagram of an architecture for separation of gNB-CU-CP and gNB-CU-UP.

FIG. 3 is a block diagram of RAN ML model management (FIGS. 4.2-1 from 3GPP TR 37.817).

FIG. 4 is a signaling diagram of ML model training at OAM, ML model inference at NG-RAN, for energy savings (FIG. 5.1.2.1-1 from 3GPP TR 37.817).

FIG. 5 is a signaling diagram of ML model training at OAM, ML model inference at NG-RAN, for load balancing (FIG. 5.2.2.1-1 from 3GPP TR 37.817).

FIG. 6 is a signaling diagram of ML model training at OAM, ML model inference at NG-RAN, for mobility optimization (FIG. 5.3.2.1-1 from 3GPP TR 37.817).

FIG. 7 is a signaling diagram of AI/ML feedback reporting associated to an action identifier or type using one procedure.

FIG. 8 is a signaling diagram of AI/ML feedback reporting associated to an action identifier or type using one AI/ML specific procedure and one non-AI/ML specific procedure.

FIG. 9 is a is a signaling diagram of AI/ML feedback reporting associated to an action identifier or type using two procedures, neither of which is specific to AI/ML.

FIG. 10 is a general signaling diagram of AI/ML event reporting.

FIG. 11 is a signaling diagram of AI/ML event reporting with a common configuration provided by a third network node.

FIG. 12 is a signaling diagram of AI/ML event reporting with reporting towards a fourth network node.

FIG. 13 is a signaling diagram of AI/ML event reporting with assistance information provided by a third network node.

FIG. 14 is a signaling diagram of AI/ML event reporting with both event configuration and event report distributed via a third network node.

FIG. 15 is a flow diagram of a method of ascertaining information related to AI/ML in a wireless communication network.

FIG. 16 is a hardware block diagram of a wireless device.

FIG. 17 is a hardware block diagram of a network node.

### DETAILED DESCRIPTION

A network node can be a RAN node, an OAM, a Core Network node, an OAM, an SMO, a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a UE, an M2M device, an MTC device, or an NB-IoT device.

The terms model training, model optimizing, model optimization, model updating are herein used interchangeably with the same meaning unless explicitly specified otherwise.

The terms model changing, modify, or similar are herein used interchangeably with the same meaning unless explicitly specified otherwise. In particular, they refer to the fact that the type, structure, parameters, or connectivity of an AI/ML model may have changed compared to a previous format/configuration of the AI/ML model.

The terms AI/ML model, AI/ML policy, AI/ML algorithm, as well as the terms, model, policy, or algorithm are herein used interchangeably with the same meaning unless explicitly specified otherwise.

References to “network nodes” herein should be understood such that a network node may be a physical node or a function or logical entity of any kind, e.g., a software entity implemented in a data center or a cloud, e.g., using one or more virtual machines, and two network nodes may well be implemented as logical software entities in the same data center or cloud.

The terms action type, action type identifier, action type ID, or type of action are used interchangeably with the same meaning, i.e., an indication of an action type

The terms action instance, specific action instance, action instance identifier, action instance ID, action ID are used interchangeably with the same meaning, i.e., an indication of an instance of a specific action.

The methods provided with the present invention are independent with respect to specific AI/ML model types or learning problems/setting (e.g., supervised learning, unsupervised learning, reinforcement learning, hybrid learning, centralized learning, federated learning, distributed learning, etc.).

Non limiting examples of AI/ML algorithms may include supervised learning algorithms, deep learning algorithms, reinforcement learning type of algorithms (such as DQN, A2C, A3C, etc.), contextual multi-armed bandit algorithms, autoregression algorithms, etc., or combinations thereof.

Such algorithms may exploit functional approximation models, hereafter referred to as AI/ML models, such as neural networks (e.g., feedforward neural networks, deep neural networks, recurrent neural networks, convolutional neural networks, etc.).

Examples of reinforcement learning algorithms may include deep reinforcement learning (such as deep Q-network (DQN), proximal policy optimization (PPO), double Q-learning), actor-critic algorithms (such as Advantage actor-critic algorithms, e.g., A2C or A3C, actor-critic with experience replay, etc), policy gradient algorithms, off-policy learning algorithms, etc.

Method of reporting associated to action instance or type

A method is executed by a first network node in a radio communication network to enable/disable and control feedback reporting associated to an action indicated by the first network node involving a second network node and/or user device, the method comprising one or more steps of:
Transmitting a FIRST REQUEST MESSAGE (e.g., an XnAP AI/ML ASSISTANCE DATA REQUEST message, XnAP Resource Status Request or similar) to a second network node, for feedback associated to a type of action (or action type) (e.g., a class of actions, such as handover actions) or to a specific action instance (e.g., a certain occurrence of an action of a certain type of action), indicated by the first network node, the FIRST REQUEST MESSAGE comprising at least an identifier of the type of action or the specific action instance to which the feedback is associated to and optionally a first feedback reporting configuration for said action type identifier (or for said specific action instance).
Receiving a FIRST RESPONSE MESSAGE (e.g., an XnAP AI/ML ASSISTANCE DATA RESPONSE message, XnAP Resource Status Request Acknowledge or similar) from the second network node indicating whether the request for feedback associated to a type of action indicated by the first network node, is successfully configured (e.g., with a full acknowledgment) or unsuccessfully configured (e.g., with a negative acknowledgment), or partially configured (e.g., with a partial failure/success where only some of the feedback information is confirmed to be reportable by the second network node).
Optionally receiving an UPDATE MESSAGE (e.g., an XnAP AI/ML ASSISTANCE DATA UPDATE message, XnAP Resource Status Update message or similar) from the second network node, comprising at least one feedback information associated to the identifier of the type of action or associated to the specific action instance provided by the first network node.

### In One Embodiment, the First Network Node May Optionally

Transmit a SECOND REQUEST MESSAGE (e.g., an XnAP HANDOVER REQUEST message) to the second network node for requesting feedback associated to the action indicated by the first network node, the SECOND REQUEST MESSAGE comprising an action identifier and a second feedback reporting configuration.
Receive a SECOND RESPONSE MESSAGE (e.g., an XnAP HANDOVER REQUEST ACKNOWLEDGE message) from the second network node to acknowledge the SECOND REQUEST MESSAGE or in general to close the procedure initialized by the SECOND REQUEST MESSAGE. The second response message may implicitly acknowledge that feedback concerning the action indicated by the first network node in the second request message can be provided. If the feedback information requested via the second request message cannot be provided, the second response message may constitute a failure for the second procedure. Alternatively, failure to be able to provide the feedback for the action requested in the second request message may be indicated in the second response message by means of an explicit indication, for example a list of feedback measurements that failed to be configured.

In one aspect, the FIRST REQUEST MESSAGE may comprise at least an action type (e.g., action type ID) or an action instance (e.g., action ID) to indicate the type of action or specific action instance, respectively, the feedback request is associated to.

The UPDATE MESSAGE may comprise one or more of the following
at least an action type identifier (e.g., action type ID) or an action instance identifier (e.g., action ID) to indicate to which type of action or specific action instance, respectively, the feedback information provided to the first network node is associated to.
An identification of the feedback information that enables the first network node to associate the feedback to a type of action or specific action instance. For instance, the feedback measurements may be reported with a measurement name that allows to map them to an Action Type.
Feedback information, e.g., measurements, which can be implicitly associated to the action type or action instance indicated by the first network node. As an example, if the first network node requested feedback only for an action consisting of “Handovers triggered for AI/ML purposes”, then the Update message may contain feedback information without any explicit action identifier. It is possible for the first network node to derive that the feedback is for the action configured at the second network node.

In one aspect, the SECOND REQUEST MESSAGE may comprise at least an action instance identifier (e.g., action ID) of an action type indicated by the FIRST REQUEST MESSAGE to indicate to which specific action instance the feedback request is associated to.

In one aspect, the FIRST REQUEST MESSAGE AND THE FIRST RESPONSE MESSAGE are part of a first signaling procedure between the first network node and the second network node, whereas the SECOND REQUEST MESSAGE is part of a second signaling procedure.

In one example, a specific action instance is indicated by means of a cause value associated to an action type.

Non-limiting examples of action type include: handover, AI/ML triggered handover, handover triggered for load balancing reasons, cell activation, cell deactivation, handover desirable for radio reasons, network energy saving, energy saving, load balancing, beam management, link adaptation, CSI estimation, or CSI compression.

Non-limiting examples of cause value can be: “AI/ML triggered handover”, “AI/ML assisted handover” or “AI/ML based handover”, “AI/ML triggered load balancing”, “AI/ML triggered network energy saving”, “AI/ML triggered mobility optimization”, “AI/ML triggered handover for load balancing reasons”, “AI/ML triggered handover for mobility optimization reasons”, “AI/ML triggered handover for energy saving reasons”, “AI/ML triggered cell activation”, “AI/ML triggered cell deactivation”.

### First Aspect of the Method of Reporting Associated to Action Instance or Type

In one aspect of the method, one procedure is used, which comprises a single mechanism to configure feedback measurement reporting and to report updates of the feedback measurements. In this aspect one message of the feedback configuration procedure comprises the request for feedback and a second message of the feedback update procedure comprises the feedback. In this aspect, the first network node sends the request for feedback associated to a type of action in the same process used to receive the feedback (e.g., in a handover procedure, the feedback is requested in the handover preparation phase, and received at handover completion). The procedures can be AI/ML associated or non-AI/ML associated.

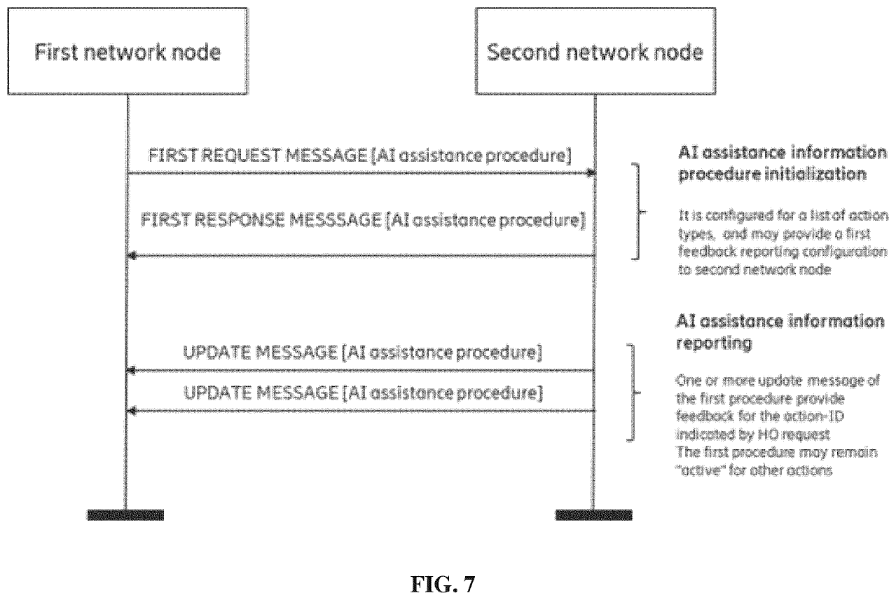

In this case, the FIRST REQUEST MESSAGE AND THE FIRST RESPONSE MESSAGE are part of a first signaling procedure between the first network node and the second network node, and the feedback reporting procedure does not need the SECOND REQUEST. This aspect of the method is illustrated in FIG. 7, where a signaling procedure based on this method is initialized to report feedback information for a specific action type or a specific action instance. In this case, in addition to an indication of an action type, the FIRST REQUEST MESSAGE, includes an indication of a specific action instance (e.g., an action-ID). In one example, such indication may be provided as part of the first feedback reporting configuration for said action type identifier.

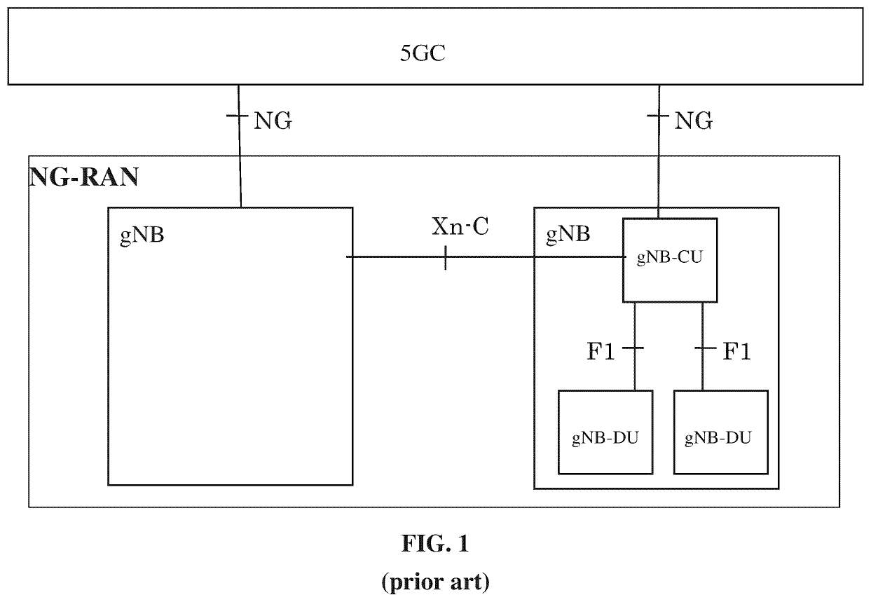

FIG. 1 shows an example with a FIRST REQUEST MESSAGE for action feedback information transmitted by first network node to a second network node, and the second network node responds by transmitting a RESPONSE MESSAGE and an UPDATE MESSAGE (in case of successful configuration of at least some feedback information reporting) for action feedback information transmitted by the second network node to the first network node.

In one example of first aspect, applied to the action type=handover, feedback for a mobility related action is requested in one message not associated to a mobility action (e.g., in an XnAP AI/ML ASSISTANCE DATA REQUEST message, or an XnAP AI/ML FEEDBACK REQUEST message, or similar). Such feedback may be requested together with a list of one or more Action Types for which the feedback needs to be reported. As an example, such action types may be indicated by listing the cause of handover events for which feedback is requested. Alternatively, the action type may be indicated by listing a number of action identifiers, where the association between action identifier and action type has been previously configured at the first and second network nodes. The feedback is transferred in a second message not associated to the same mobility action (e.g., in an XnAP AI/ML ASSISTANCE DATA UPDATE message, or an XnAP AI/ML FEEDBACK UPDATE message, or similar). Such feedback may be transferred in a way that it is associated to the action type to which it corresponds. As an example, the feedback results may be listed in a way that each result is signaled together with the handover cause and the interface application protocol ID (uniquely identifying the UE over the signaling interface) of the handover for which the feedback is collected. In another example, the feedback results may be listed in a way that each feedback measurement is associated to an Action identifier.

### Second Aspect of the Method of Reporting Associated to Action Instance or Type

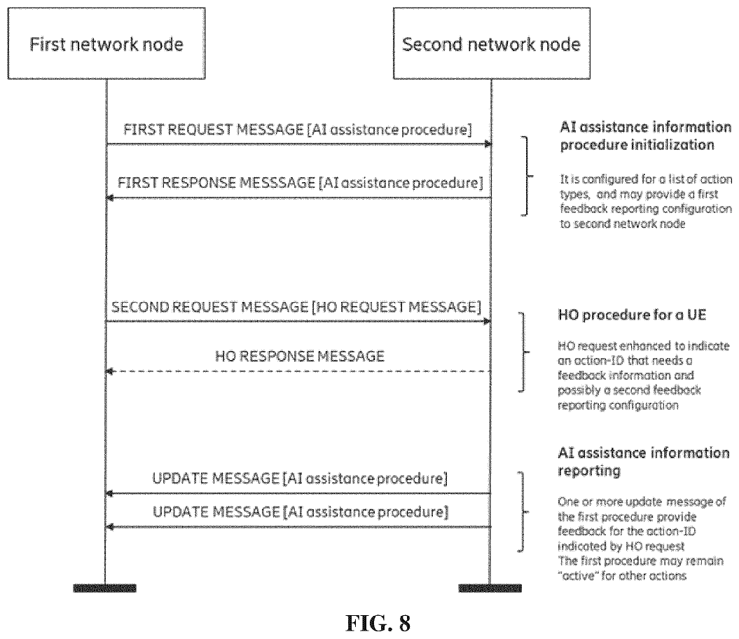

In a second aspect, two procedures are used, one of them is specific for AI/ML based/assisted use case and another one is not specific for AI/ML based/assisted use case. The first procedure is used to request and initialize feedback information associated to a type of action, while and the second procedure is used to provide the feedback information for a specific action instance and possibly to modify the reporting configuration or conditions initialized with the first procedure by means of a second feedback reporting configuration. The steps used in this variant are described in FIG. 8.

In this case, the FIRST REQUEST MESSAGE AND THE FIRST RESPONSE MESSAGE are part of a first signaling procedure between the first network node and the second network node, whereas the SECOND REQUEST MESSAGE is part of a second signaling procedure. The method is illustrated in FIG. 8, where the first network node transmits a REQUEST MESSAGE FOR ACTION FEEDBACK information to a second network node, and the second network node responds by transmitting a RESPONSE MESSAGE or an UPDATE MESSAGE FOR ACTION FEEDBACK information to the first network node.

FIG. 8 is an illustration of a variant of the method where a first procedure is used to initialize feedback reporting for a type of action, while a second procedure is used to provide the feedback and eventually to modify the reporting conditions.

The first network node initiates a first procedure towards the second network node comprising a FIRST REQUEST MESSAGE to receive feedback associated to a type of action, e.g., by means of action type identifier (e.g., the first procedure can be an AI/ML Assistance Data Reporting Initiation procedure, indicating that feedback associated to type of action (e.g., a specific type of handover) is requested). This first procedure has the purpose to enable (start) or disable (stop) the collection of feedback associated to a certain type of action. With the FIRST REQUEST MESSAGE, the first network node may provide a first feedback reporting configuration for said action type identifier, comprising instructions and conditions for reporting information for all actions of the indicated type. In this first request message, the first network node may request feedback for one or more action types. Such feedback may be requested together with a list of one or more Action Types for which the feedback needs to be reported. As an example, such action types may be indicated by listing the handover cause of handover events for which feedback is requested. Alternatively, the action type may be indicated by listing a number of action identifiers, where the association between action identifier and action type has been previously configured at the first and second network nodes.

The first network node later may initiate a second procedure, by means of a SECOND REQUEST MESSAGE, comprising an explicit or implicit request to receive feedback for an action of the same type of action specified in the first procedure. An example of second procedure can be an XnAP Handover Preparation procedure and the request for feedback for the action of type=handover can be explicitly signaled as part of the XnAP HANDOVER REQUEST message, or implicitly signaled by the fact that the request for feedback is within in the XnAP HANDOVER REQUEST message. In this case, the HANDOVER REQUEST message may be enhanced to include an identifier of a specific action instance (e.g., an action ID) indicating a specific instance of the type of action for which the first network node has requested feedback reporting by means of the first procedure initialization. The HANDOVER REQUEST message may further be enhanced to comprise a second feedback reporting configuration for said action identifier, which may comprise instructions and conditions for reporting feedback information associated to the indicated action identifier that may override or integrate instructions and conditions provided by the first feedback reporting configuration applicable to all actions of the indicated type. In one example of the second variant, applied to the action type (e.g., handover), feedback for a mobility related action is requested in one message associated to a mobility action (e.g., an XnAP HANDOVER REQUEST message), and the feedback is transferred in a second message not associated to the same mobility action (e.g., in an XnAP AI/ML ASSISTANCE DATA UPDATE message, or an XnAP AI/ML FEEDBACK UPDATE message, or similar). Such feedback may be transferred in a way that it is associated to the action type to which it corresponds. As an example, the feedback results may be listed in a way that each result is signaled together with the handover cause and the interface application protocol ID (uniquely identifying the UE over the signaling interface) of the handover for which the feedback is collected. In another example, the feedback results may be listed in a way that each feedback measurement is associated to an Action identifier.

### Third Aspect of the Method of Reporting Associated to Action Instance or Type

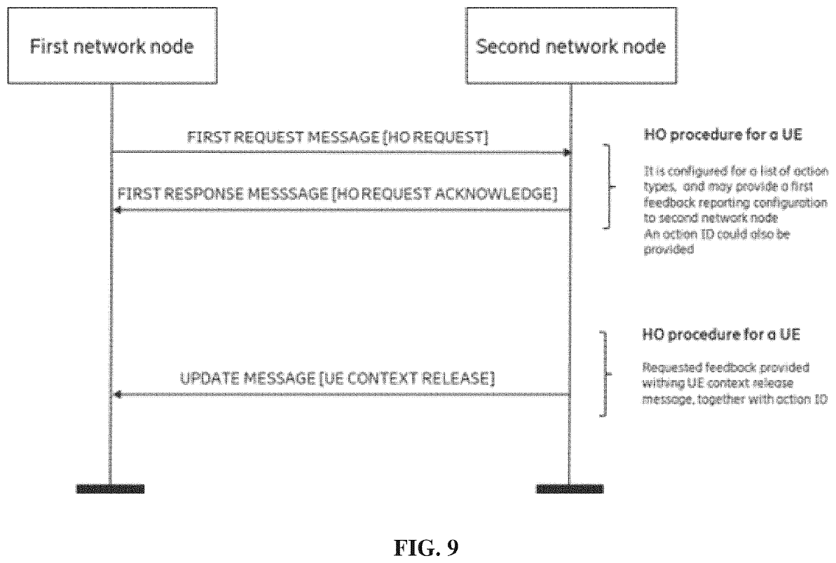

In a third aspect, which is derived from the second aspect and that follows the same methods descriptions, two procedures are used, and none of them is specific for AI/ML. The first procedure is used to request and initialize feedback information associated to a type of action or to a specific action instance, while the second procedure is used to provide the feedback information for the type of action (or for the specific action instance), and possibly to modify the reporting configuration or conditions initialized with the first procedure by means of a second feedback reporting configuration. Examples of procedures that can be considered include: handover (one procedure for preparation, one procedure for execution/completion, conditional handover (preparation and execution), PSCell Change (preparation and execution), conditional PSCell change (preparation and execution). The steps used in this variant are described in FIG. 9.

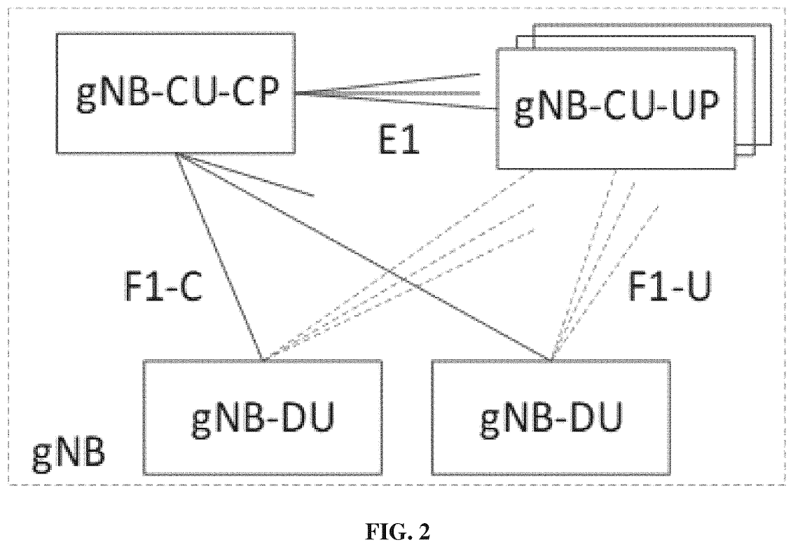

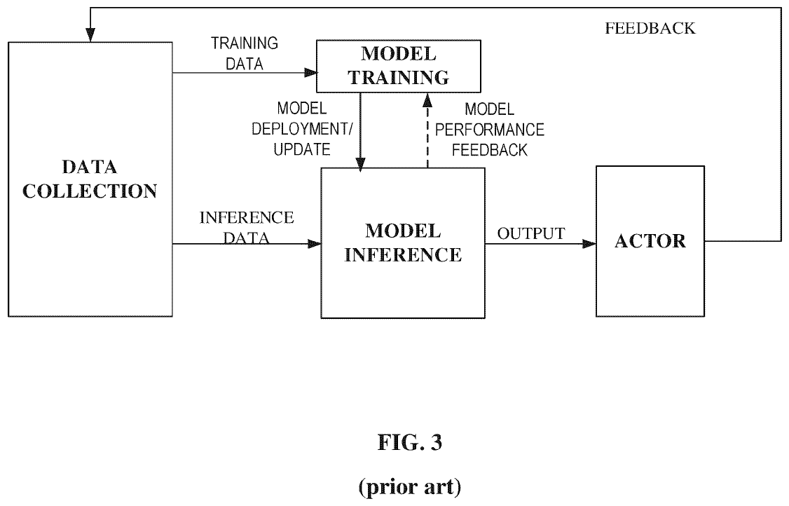

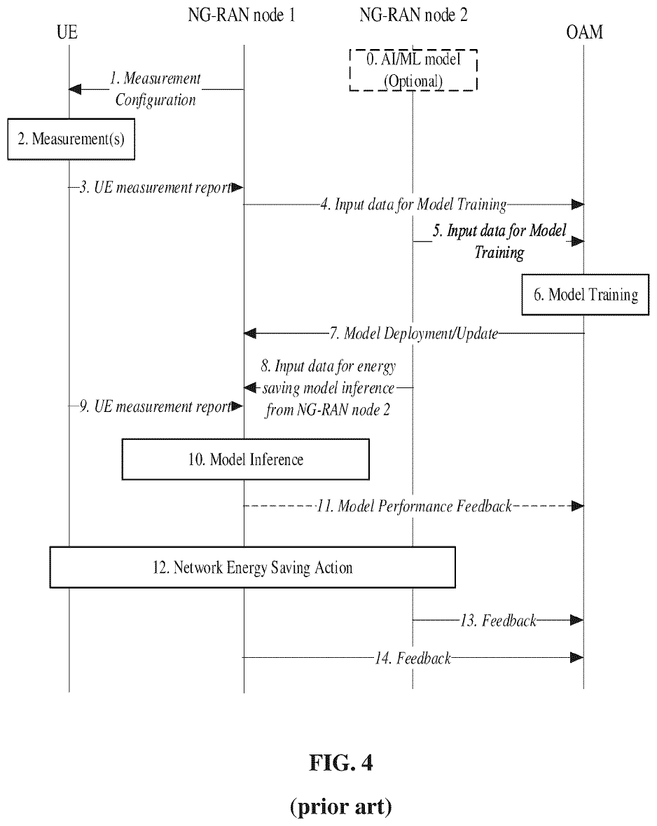

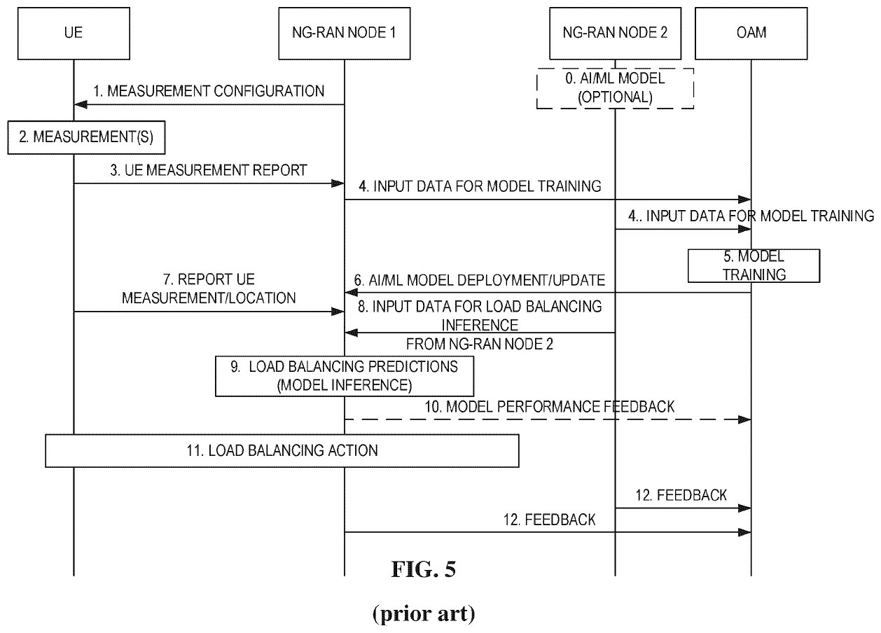

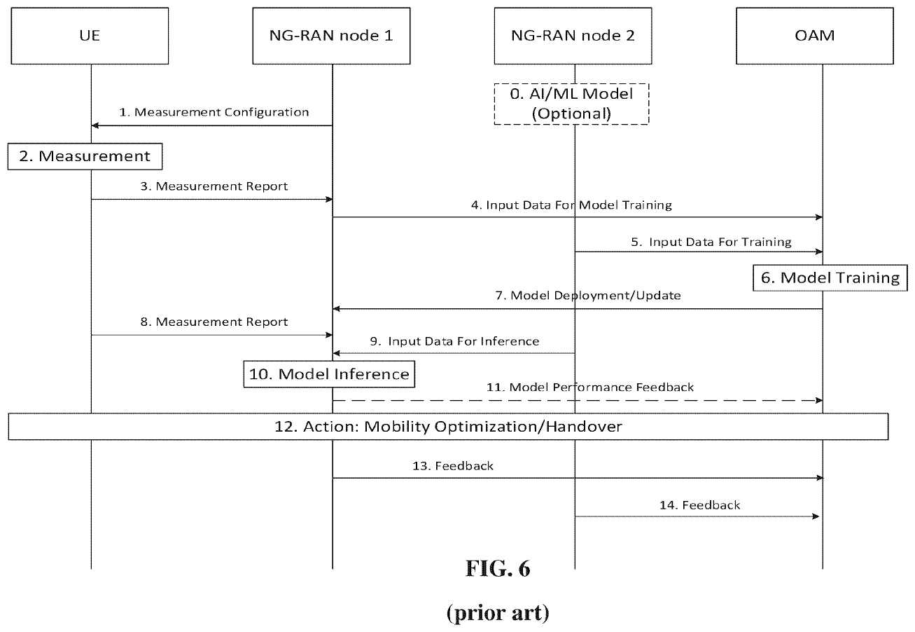

FIG. 2 is an Illustration of an aspect of the method where a first procedure is used to initialize feedback reporting for a type of action, while a second procedure is used to provide the feedback and eventually to modify the reporting conditions. Both procedures are not dedicated to AI/ML assistance information.

In one example of the third aspect, applied to the action type=handover, feedback for a mobility related action is requested in one message associated to a mobility action (e.g., an XnAP HANDOVER REQUEST message), and the feedback is transferred in a second message associated to the same mobility action (e.g., an XnAP UE CONTEXT RELEASE message from target network node to source network node following a HANDOVER REQUEST ACKNOWLEDGE message from target network node to source network node).

### First and Second Feedback Configuration for Methods of Reporting Associated to Action Instance or Type

In one aspect, the first feedback reporting configuration transmitted with the FIRST REQUEST MESSAGE, comprises instructions and conditions for reporting feedback information that are common for all actions instances that belong to the same action type, e.g., as indicated by an action type indicator within the FIRST REQUEST MESSAGE itself. For instance, the first network node may provide a common set of instructions and conditions for reporting feedback information associated to all actions of type “handover”, or type “energy savings”, etc.

In one aspect, the first feedback reporting configuration transmitted with the FIRST REQUEST MESSAGE, comprises instructions and conditions for reporting feedback information associated to a specific action instance of a specific action type. In this case, the FIRST REQUEST MESSAGE may provide an action identifier that includes an action-ID and possibly an action type identifier. The action type identifier may or may not be transmitted with the FIRST REQUEST MESSAGE. This case may occur in the first aspect of the method, where only one process is used (made of a configuration part and of feedback update reporting part), with one message of the procedure comprising the request for feedback and a second message of the procedure comprising the feedback.

In one aspect, the second feedback reporting configuration transmitted with the SECOND REQUEST MESSAGE, comprises instructions and conditions for reporting feedback information associated to a specific action identifier (also indicated in the SECOND REQUEST MESSSAGE) that may override or integrate instructions and conditions provided by the first feedback reporting configuration (with the FIRST REQUEST MESSSAGE) that applicable/common to all actions of the indicated type.

In the parts below, a “feedback sample” may refer to a measurement value for a feedback metric, or at the feedback measurement values reported in a message to update the feedback information.

In one aspect, the first and/or the second feedback reporting configuration may consist of one or more parameters in the group of:
a time interval during which feedback is to be collected.
A condition that determines stopping of UE performance feedback signaling. In one embodiment such condition is associated with the removal of the UE context at the first network node. As an example, such condition could be marked by the signaling of messages between the first and second node that instruct on removal of the UE context, e.g. signaling of the Xn UE Context Release message.
An indication to report at least one feedback metric in a list of possible metrics. Non-limiting examples of feedback metrics may include throughput in DL/UL, spectral efficiency, packet delay in DL/UL, latency, packet error rate UL/DL, block error rate, number of packets lost in UL/DL, packet loss UL/DL, jitter in UL/DL etc.
a minimum, or a range, or a maximum number of samples to collect for valid feedback. Namely, the number of feedback updates requested by the first network node.
A minimum number of wanted feedback samples, e.g., in the form of feedback update messages, or valid feedback samples to be reported for at least one of the indicated feedback metrics. If more than one feedback metric is requested, each feedback metric may be configured to be reported with a dedicated minimum number of samples, or with the same minimum number of samples (in which case a single indication could be sufficient).
A number of wanted feedback samples or valid feedback samples to be reported for at least one of the indicated feedback metrics. If more than one feedback metric is requested, each feedback metric may be configured to be reported with a dedicated number of samples, or with the same number of samples (in which case a single indication could be sufficient).
A maximum number of wanted feedback samples or valid feedback samples to be reported for at least one of the indicated feedback metrics. If more than one feedback metric is requested, each feedback metric may be configured to be reported with a dedicated maximum number of samples, or with the same maximum number of samples (in which case a single indication could be sufficient).
maximum time allowed for collecting the feedback
a minimum time for collecting the feedback
a minimum set of data constituting a valid feedback (for instance, an indication that providing feedback in terms of DL throughput is ok, providing a feedback in terms of packet loss without the DL throughput is not ok).
One or more conditions or events to transmit the feedback information reporting. Non limiting examples of conditions or events could include:
   target network node waits in sending the message until the determination of the feedback is completed;
   target network node waits in sending the message until the determination of the feedback is completed, provided that the feedback is determined within a certain time from a reference;
   target network node sends the feedback subsequently to the completion of a procedure used to execute the action (e.g., a handover procedure or UE context release procedure in case of handover action);
   target network node sends an indication that feedback associated to the action type is available (or will be available);
   target network node sends an indication that feedback associated to the action instance is available (or will be available);
   target network node sends an indication that feedback associated to the action type is not available (or will not be available);
   target network node sends an indication that feedback associated to the action instance is not available (or will not be available).
One or more conditions or events to terminate the reporting of feedback information associated to the indicated action-ID or action type. Additionally, the configuration may require the second node to indicate the condition that terminated the feedback information reporting, such as a cause value for termination of reporting. Non limiting examples of conditions or events for reporting termination, and/or cause values to be reported, could include:
   Maximum time allowed for collecting the above information
   Maximum number of measuring instances with no measurement available
   Maximum number of requested measuring instances reached
   Minimum number of requested measuring instances reached
   Insufficient feedback samples
   Radio link failure
   Radio conditions (e.g., minimum/maximum level of RSRP, RSRQ, SINR, RSSI) exceeding or being below a certain threshold.
   User device with no data traffic (e.g., in uplink or in downlink)
   . . .
One or more cause special values to be reported in case of
   Feedback information not available or measurable
   Invalid feedback information
Sampling time
Minimum set of data (e.g., throughput alone is fine, only packet loss is of no use, throughput).
A request to indicate information related to the cell status, such as resource status utilization, when the required feedback information samples are collected. Non limiting examples of information requested could include:
   Cell load (e.g., expressed in terms of PRB utilization)
   Cell capacity (e.g., composite available capacity, or another metric)
   Number of active UEs
   Number of idle UEs
   Radio conditions (e.g., minimum/maximum level of RSRP, RSRQ, SINR, RSSI).
A list of cause values indicating the actions for which feedback needs to be collected and reported. As an example, such cause values may be associated to handover actions. In this case, for each UE that handovers to the second network node and where the handover cause is equal to one or more of the listed causes, feedback should be provided. Feedback in this case may consist of UE performance after handing over to a cell of the second network node.
A list of identifiers, where each identifier has been configured a priori at first and second network node so that the mapping between the identifier and an action type is known. Such list of Action identifiers indicates to the second network node that if an action corresponding to one of the identifiers takes place, then the second network node shall send feedback to the first network node concerning such action. Feedback in this case may consist of UE performance after the action has taken place.

In one aspect, the first and/or the second feedback reporting configuration may further indicate that feedback information associated to an action type and/or to an instance of an action type should be reported by means of a UE context release message.

In one aspect, the first and/or the second feedback reporting configuration may further indicate that feedback information associated to an action type and/or to an instance of an action type should be until a UE context release message is transmitted to or received by the first network node.

### Example of Method Associated to Action Instance or Type Used for Feedback Related to Handover Actions

Hereafter are further described some methods disclosed herein using user mobility due to handover as a non-limiting example for which a first network node may request feedback information to a second network node. However, the same methods can be applied to other mobility procedures, such as a PSCell change, a conditional handover, or a conditional PSCell change, or other network procedures.

In one scenario, the first network node determines a handover action based at least in part on the output produced by an AI/ML model. The handover can be associated to a load balancing decision where a user is moved from a first cell of the first network node to a second cell of the second network node.

In a first step, the first network node (the source node of the handover) during the handover preparation sends to the second network node (the target node of the handover), a handover request (e.g., in an XnAP HANDOVER REQUEST message) comprising one or more of: an identify of an action (e.g., an ACTION-ID, a specific handover cause, or equivalent) for which a feedback is expected from the second network node, an explicit request to provide feedback for the action, a feedback configuration to provide information to the second network node on how to determine the requested feedback.

In a second step, the target network node collects the requested feedback according to the request from the source network node. To determine the feedback to be sent to the source network node, the target network node can optionally collect some piece of information from the handed over UE. In the process of collecting from the handed over UE the needed information, the target network node can provide to the UE some of the feedback configuration parameters received by the source network node (or parameters derived from the feedback configuration parameters received by the source network node). If/when the target network node receives from the handed over UE information useful for determining the feedback requested by the source network node, it can use it.

In one variant of a third step, the target network node sends the feedback associated to the action type or to a specific action instance in a message that is associated to the handover procedure, for example an XnAP UE CONTEXT RELEASE message.

In another variant of the third step, the target network node sends the feedback associated to the action type or to a specific action instance in a message that is not associated to the handover procedure, for example an XnAP AI/ML ASSISTANCE DATA UPDATE message, or an XnAP AI/ML FEEDBACK UPDATE message, or similar.
(alternative 1 to provide feedback) In one case the target network node sends the message meant to include the feedback (e.g., the XnAP UE CONTEXT RELEASE) only when the feedback has been determined (the target network node waits in sending the message until the determination of the feedback is completed), provided that the feedback is determined within a certain time from a reference (e.g., from the time of reception of the HANDOVER REQUEST).
(alternative 2 to provide feedback) In another case, the target network node first sends a message associated to the handover procedure not containing the feedback associated to the action type nor to the specific action instance, and later sends another message not associated to the handover procedure and containing the feedback associated to the action type or to the specific action instance.
(alternative 3 to provide feedback) In yet another case, the target network node first sends a message associated to the handover procedure containing the specific action instance but no feedback associated to the action type (e.g., an XnAP HANDOVER REQUEST ACKNOWLEDGE, or an XnAP UE CONTEXT RELEASE message). At a later stage, the target network node sends another message not associated to the handover procedure (e.g., an XnAP AI/ML ASSISTANCE DATA UPDATE message, or an XnAP AI/ML FEEDBACK UPDATE message, or similar), containing feedback associated to the action type and feedback associated to the action instance. In this scenario, the first message has the purpose to acknowledge the request of the source network node to receive the feedback, while the subsequent message carries the feedback (and the associated action identifier).
(alternative 4 to provide feedback, similar to alternative 3) In another case, the target network node first sends a message associated to the handover procedure containing the specific action instance and an indication that feedback associated to the action type is available (or it will be available), At a later stage, the target network node sends another message not associated to the handover procedure (e.g., an XnAP AI/ML ASSISTANCE DATA UPDATE message, or an XnAP AI/ML FEEDBACK UPDATE message, or similar), containing the specific action instance and the feedback associated to the action type. In this scenario, the first message has the purpose to acknowledge the request of the source network node to receive the feedback and to inform that feedback is available (or will be available), while the subsequent message carries the feedback (and the associated action identifier).
(alternative 5 to provide feedback) In another case, the target network node first sends a message associated to the handover procedure containing the specific action instance and an indication that feedback associated to the action type is not available (or it will not be available).

In another example of the methods applied to handover actions the first message signaled by the first network node may consist of the following, where, as a non limiting use case, the message is assumed to be signaled over the Xn interface.

### AI-ML Assistance Data Request

This message is sent by NG-RAN node1 to NG-RAN node2 to initiate the requested assistance data reporting in support to AI/ML functions, according to the parameters given in the message.
Direction: NG-RAN node₁® NG-RAN node₂.

| IE/Group | | | IE type & | Semantics | | Assigned |
|---|---|---|---|---|---|---|
| Name | Presence | Range | reference | description | Criticality | Criticality |
| Message | M | | 9.2.3.1 | | YES | reject |
| Type | | | | | | |
| NG-RAN | M | | INTEGER | Allocated by NG- | YES | reject |
| node1 | | | (1 . . . | RAN node₁ | | |
| Measurement | | | 4095, . . .) | | | |
| ID | | | | | | |
| NG-RAN | C- | | INTEGER | Allocated by NG- | YES | ignore |
| node2 | ifRegistrat- | | (1 . . . | RAN node₂ | | |
| Measurement | ionRequestStoporAdd | | 4095, . . .) | | | |
| ID | | | | | | |
| Registration | M | | ENUMER- | Type of request | YES | reject |
| Request | | | ATED(start, | for which the | | |
| | | | stop, | assistance data | | |
| | | | add, . . .) | is required. | | |
| Report | C- | | BITSTRING | Each position in | YES | reject |
| Characteristics | ifRegistra- | | (SIZE(128)) | the bitmap | | |
| | tionRequestStart | | | indicates | | |
| | | | | measurement | | |
| | | | | object the NG- | | |
| | | | | RAN node 2 is | | |
| | | | | requested to | | |
| | | | | report. | | |
| | | | | First Bit = | | |
| | | | | Predicted Radio | | |
| | | | | Resources | | |
| | | | | Periodic, | | |
| | | | | Second Bit = | | |
| | | | | Current Energy | | |
| | | | | Efficiency | | |
| | | | | Periodic, | | |
| | | | | Third Bit = | | |
| | | | | Predicted Energy | | |
| | | | | Efficiency | | |
| | | | | Periodic (FFS), | | |
| | | | | Fourth Bit = UE | | |
| | | | | Performance | | |
| | | | | Indicator. | | |
| | | | | Other bits shall | | |
| | | | | be ignored by the | | |
| | | | | NG-RAN node 2. | | |
| Cell To | | 0 . . . 1 | | Cell ID list to | YES | ignore |
| Report | | | | which the request | | |
| List | | | | applies. | | |
| >Cell To | | 1 . . . | | | — | |
| Report | | <maxnoofCellsinNG- | | | | |
| Item | | RANnode> | | | | |
| >>Cell | M | | Global | | — | |
| ID | | | NG-RAN | | | |
| | | | Cell | | | |
| | | | Identity | | | |
| | | | 9.2.2.27 | | | |
| Reporting | O | | ENUMER- | Periodicity that | YES | ignore |
| Periodicity | | | ATED(500 | can be used for | | |
| | | | ms, | reporting. | | |
| | | | 1000 ms, | | | |
| | | | 2000 ms, | | | |
| | | | 5000 ms, | | | |
| | | | 10000 | | | |
| | | | ms, . . .) | | | |
| Cause | | 0 . . . 1 | | | YES | ignore |
| Value List | | | | | | |
| >Cause | | 1 . . . | | | — | — |
| Value | | <MaxNumberofCause> | | | | |
| Item | | | | | | |
| >>Cause | M | | 9.2.3.2 | Cause value of | — | — |
| | | | | handovers for | | |
| | | | | which UE | | |
| | | | | Performance | | |
| | | | | Feedback is | | |
| | | | | requested | | |

As can be seen, the Cause Value List IE provide means for the second network node to identify the actions upon which feedback needs to be provided, namely such actions are handover procedures for which the listed handover cause values were used. To generalize this example, the list of cause values could be used to identify a list of actions that goes beyond handovers, namely that includes also other actions such as SN Addition, so long as the cause for the action is listed in the first message described above.

Following the same example, the message used to report feedback updates may be described as follows:

### AI-ML Assistance Data Update

This message is sent by NG-RAN node2 to NG-RAN node1 to report the results of the requested assistance data.
Direction: NG-RAN node2® NG-RAN node1.

| IE/Group | | | IE type & | Semantics | | Assigned |
|---|---|---|---|---|---|---|
| Name | Presence | Range | reference | description | Criticality | Criticality |
| Message | M | | 9.2.3.1 | | YES | ignore |
| Type | | | | | | |
| NG-RAN | M | | INTEGER | Allocated by NG-RAN | YES | reject |
| node1 | | | (1 . . . | node₁ | | |
| Measurement | | | 4095, . . .) | | | |
| ID | | | | | | |
| NG-RAN | M | | INTEGER | Allocated by NG-RAN | YES | reject |
| node2 | | | (1 . . . | node₂ | | |
| Measurement | | | 4095, . . .) | | | |
| ID | | | | | | |
| Energy | O | | INTEGER | Value 1 indicates the | | |
| Efficiency | | | (0 . . . 100) | minimum measured | | |
| | | | | Energy Efficiency and | | |
| | | | | 100 indicates the | | |
| | | | | maximum measured | | |
| | | | | Energy Efficiency. | | |
| | | | | Energy Efficiency | | |
| | | | | should be measured | | |
| | | | | on a linear scale | | |
| Predicted | O | | INTEGER | Value 1 indicates the | | |
| Energy | | | (0 . . . 100) | minimum Predicted | | |
| Efficiency | | | | Energy Efficiency and | | |
| (presence | | | | 100 indicates the | | |
| of this IE is | | | | maximum Predicted | | |
| FFS) | | | | Energy Efficiency. | | |
| | | | | Predicted Energy | | |
| | | | | Efficiency should be | | |
| | | | | measured on a linear | | |
| | | | | scale | | |
| Cell | | 0 . . . 1 | | | YES | ignore |
| Measurement | | | | | | |
| Result | | | | | | |
| >Cell | | 1 . . . | | | YES | ignore |
| Measurement | | <maxnoofCellsinNG- | | | | |
| Result | | RANnode> | | | | |
| Item | | | | | | |
| >>Cell | M | | Global NG- | | — | |
| ID | | | RAN Cell | | | |
| | | | Identity | | | |
| | | | 9.2.2.27 | | | |
| >>Predicted | O | | 9.2.3.xx | Indicates the | | |
| Radio | | | | predicted values of | | |
| Resource | | | | reported resource | | |
| Status | | | | measurements | | |
| >>UE | O | 1 . . . | | | | |
| Performance | | <maxnoofFeedbackUEs> | | | | |
| Indicator | | | | | | |
| List | | | | | | |
| >>>UE | M | | 9.2.3.yy | | | |
| Performance | | | | | | |
| Measurements | | | | | | |
| >>>UE | O | | NG-RAN | | YES | ignore |
| Assistant | | | node UE | | | |
| Identifier | | | XnAP ID | | | |
| | | | 9.2.3.16 | | | |

As can be seen, the UE Performance Indicator List IE contains UE Performance Measurements associated to a UE Assistant Identifier. Such UE Assistant Identifier enables the first network node to identify the UE context for the UE for which performance metrics were reported and to deduce that the UE has been handed over to the second network node with a specific handover cause (listed in the first message above). Namely, the association between feedback and action is made by means of a UE identifier that allows implicitly to lead to the action the feedback is relative to.

The example above may be modified, as follows:

### AI-ML Assistance Data Request

This message is sent by NG-RAN node1 to NG-RAN node2 to initiate the requested assistance data reporting in support to AI/ML functions, according to the parameters given in the message.
Direction: NG-RAN node₁® NG-RAN node₂.

| IE/Group | | | IE type & | Semantics | | Assigned |
|---|---|---|---|---|---|---|
| Name | Presence | Range | reference | description | Criticality | Criticality |
| Message | M | | 9.2.3.1 | | YES | reject |
| Type | | | | | | |
| NG-RAN | M | | INTEGER | Allocated by | YES | reject |
| node1 | | | (1 . . . | NG-RAN | | |
| Measurement | | | 4095, . . .) | node₁ | | |
| ID | | | | | | |
| NG-RAN | C- | | INTEGER | Allocated by | YES | ignore |
| node2 | ifRegistra- | | (1 . . . | NG-RAN | | |
| Measurement | tionRequestStoporAdd | | 4095, . . .) | node₂ | | |
| ID | | | | | | |
| Registration | M | | ENUMER- | Type of | YES | reject |
| Request | | | ATED(start, | request for | | |
| | | | stop, | which the | | |
| | | | add, . . .) | assistance | | |
| | | | | data is | | |
| | | | | required. | | |
| Report | C- | | BITSTRING | Each position | YES | reject |
| Characteristics | ifRegistra- | | (SIZE(128)) | in the bitmap | | |
| | tionRequestStart | | | indicates | | |
| | | | | measurement | | |
| | | | | object the NG- | | |
| | | | | RAN node 2 is | | |
| | | | | requested to | | |
| | | | | report. | | |
| | | | | First Bit = | | |
| | | | | Predicted Radio | | |
| | | | | Resources | | |
| | | | | Periodic, | | |
| | | | | Second Bit = | | |
| | | | | Current Energy | | |
| | | | | Efficiency | | |
| | | | | Periodic, | | |
| | | | | Third Bit = | | |
| | | | | Predicted | | |
| | | | | Energy Efficiency | | |
| | | | | Periodic | | |
| | | | | (FFS), | | |
| | | | | Fourth Bit = | | |
| | | | | UE | | |
| | | | | Performance | | |
| | | | | Indicator. | | |
| | | | | Other bits | | |
| | | | | shall be | | |
| | | | | ignored by the | | |
| | | | | NG-RAN node | | |
| | | | | 2. | | |
| Cell To | | 0 . . . 1 | | Cell ID list to | YES | ignore |
| Report | | | | which the | | |
| List | | | | request | | |
| | | | | applies. | | |
| >Cell To | | 1 . . . | | | — | |
| Report | | <maxnoofCellsinNG- | | | | |
| Item | | RANnode> | | | | |
| >>Cell | M | | Global | | — | |
| ID | | | NG-RAN | | | |
| | | | Cell | | | |
| | | | Identity | | | |
| | | | 9.2.2.27 | | | |
| Reporting | O | | ENUMER- | Periodicity that | YES | ignore |
| Periodicity | | | ATED(500 | can be used | | |
| | | | ms, | for reporting. | | |
| | | | 1000 ms, | | | |
| | | | 2000 ms, | | | |
| | | | 5000 ms, | | | |
| | | | 10000 ms, | | | |
| | | | . . .) | | | |
| Action ID | | 0 . . . 1 | | | YES | ignore |
| List | | | | | | |
| >Action | | 1 . . . | | | — | — |
| ID Item | | <MaxNumberofActionIDs> | | | | |
| >>Action | M | | INTEGER | Identifier of | — | — |
| ID | | | (1, . . . , | the action for | | |
| | | | 256, . . .) | which UE | | |
| | | | | Performance | | |
| | | | | Feedback is | | |
| | | | | requested | | |

### AI-ML Assistance Data Update

This message is sent by NG-RAN node2 to NG-RAN node1 to report the results of the requested assistance data.
Direction: NG-RAN node₂® NG-RAN node₁.

| IE/Group | | | IE type & | Semantics | | Assigned |
|---|---|---|---|---|---|---|
| Name | Presence | Range | reference | description | Criticality | Criticality |
| Message | M | | 9.2.3.1 | | YES | ignore |
| Type | | | | | | |
| NG-RAN | M | | INTEGER | Allocated by NG- | YES | reject |
| node1 | | | (1 . . . | RAN node₁ | | |
| Measurement | | | 4095, . . .) | | | |
| ID | | | | | | |
| NG-RAN | M | | INTEGER | Allocated by NG- | YES | reject |
| node2 | | | (1 . . . | RAN node₂ | | |
| Measurement | | | 4095, . . .) | | | |
| ID | | | | | | |
| Energy | O | | INTEGER | Value 1 indicates | | |
| Efficiency | | | (0 . . . 100) | the minimum | | |
| | | | | measured Energy | | |
| | | | | Efficiency and 100 | | |
| | | | | indicates the | | |
| | | | | maximum measured | | |
| | | | | Energy Efficiency. | | |
| | | | | Energy Efficiency | | |
| | | | | should be measured | | |
| | | | | on a linear scale | | |
| Predicted | O | | INTEGER | Value 1 indicates | | |
| Energy | | | (0 . . . 100) | the minimum | | |
| Efficiency | | | | Predicted Energy | | |
| (presence | | | | Efficiency and 100 | | |
| of this IE | | | | indicates the | | |
| is FFS) | | | | maximum Predicted | | |
| | | | | Energy Efficiency. | | |
| | | | | Predicted Energy | | |
| | | | | Efficiency should be | | |
| | | | | measured on a | | |
| | | | | linear scale | | |
| Cell | | 0 . . . 1 | | | YES | ignore |
| Measurement | | | | | | |
| Result | | | | | | |
| >Cell | | 1 . . . | | | YES | ignore |
| Measurement | | <maxnoofCellsinNG- | | | | |
| Result | | RANnode> | | | | |
| Item | | | | | | |
| >>Cell | M | | Global | | — | |
| ID | | | NG-RAN | | | |
| | | | Cell | | | |
| | | | Identity | | | |
| | | | 9.2.2.27 | | | |
| >>Predicted | O | | 9.2.3.xx | Indicates the | | |
| Radio | | | | predicted values of | | |
| Resource | | | | reported resource | | |
| Status | | | | measurements | | |
| >>UE | O | 1 .. | | | | |
| Performance | | <maxnoofFeedbackUEs> | | | | |
| Indicator | | | | | | |
| List | | | | | | |
| >>>Performance | M | | 9.2.3.yy | | | |
| Measurements | | | | | | |
| >>>Action ID | O | | INTEGER | Identifier of the | YES | ignore |
| | | | (1, . . . , | action for which UE | | |
| | | | 256, . . .) | Performance | | |
| | | | | Feedback is | | |
| | | | | provided | | |

In the example above, an explicit Action ID list is included in the first message, while an explicit association between feedback information and action ID for the action to which feedback corresponds to is provided in the second message.

### Applicability of the Methods of Feedback Reporting Associated to Action Instance or Type

Regarding possible scenarios of applicability of the methods:
the first network node and/or the second network node can be different RAN nodes (e.g., two gNBs, or two eNBs, or two en-gNBs, or two ng-eNBs)
the first network node and/or the second network node can be different nodes/functions of a same RAN node (e.g., a gNB-CU-CP and a gNB-DU, or a gNB-CU-CP and a gNB-CU-UP)
the first network node can be a RAN node (e.g., a gNBs, or a eNBs, or a en-gNBs, or a ng-eNBs) and the second network node can be component/nodes/functions of a second RAN node (e.g., gNB-CU-CP)
the first network node and/or the second network node can pertain to the same Radio Access Technology (e.g., e.g., E-UTRAN, NG-RAN, WiFi, etc.) or to different Radio Access Technologies (e.g., one to NR and the other to E-UTRAN or WiFi)
the first network node and/or the second network node can pertain to the same RAN system (e.g., E-UTRAN, NG-RAN, WiFi, etc) or to different RAN systems (e.g., one to NG-RAN and the other to E-UTRAN)
the first network node and the second network node may be connected via a direct signaling connection (e.g., two gNB via XnAP), or an indirect signaling connection (e.g., an e-NB and a gNB via S1AP, NGAP and one or more Core Network nodes, e.g., an MME and an AMF)
the first network node can be a management system, such as the OAM system or the SMO, while the second network node can consist of a RAN node or function.
The first network node can be a RAN node or function while the second network node can be a management system, such as the OAM or the SMO.
the first network node can be a core network node or function, such a 5GC function, while the second network node can consist of a RAN node or function.
The first network node can be a RAN node or function while the second network node can be a core network node or function, such a 5GC function.

### More Generally, Aspects of AI/ML Event Reporting

A first network node determines (or obtains at least in part from a third network node in a FOURTH MESSAGE) at least an event configuration pertaining to event(s) for AI/ML in RAN. An event configuration comprises an event definition configuration (identifiers, parameters, indications, and conditions to be used for determining the fulfillment of the event(s)) and an event reporting configuration (parameters indicating which information is to be reported, when and how). The event configuration can be identified by its own identifier (e.g., an event configuration identifier) which can be signaled in any of the messages described in the present disclosure.

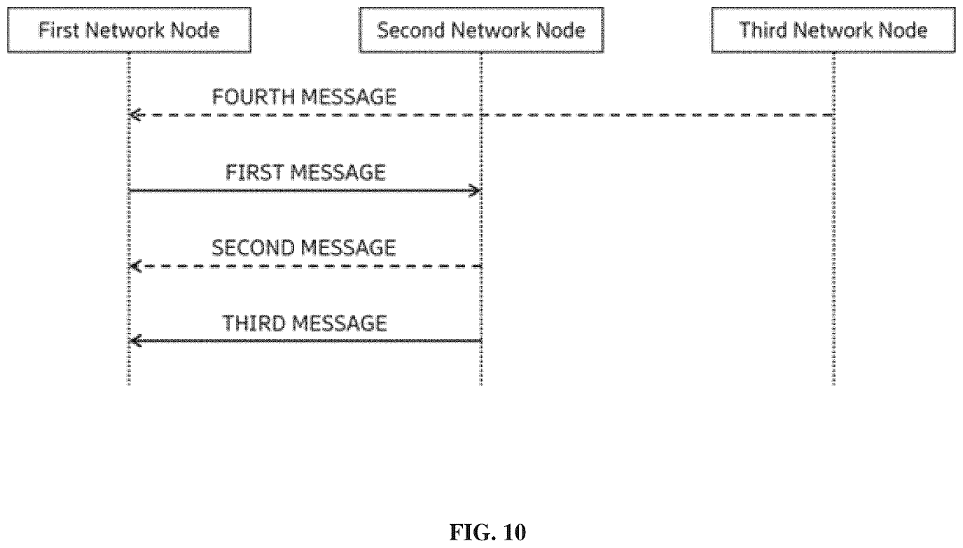

FIG. 10 is a signaling diagram illustrating the method of AI/ML feedback related to events.

The first network node sends to a second network node (or to a plurality of second network nodes) a FIRST MESSAGE comprising an event configuration (i.e., the event definition configuration and the event reporting configuration) of at least one event for AI/ML in RAN, requesting the second network node(s) to report to the first network node corresponding event reports for AI/ML in RAN (i.e., information associated to the event for AI/ML in RAN) in one or more THIRD MESSAGEs according to the event reporting configuration. In one embodiment, an event configuration can relate to multiple events for AI/ML in RAN, meaning that the event definition configuration can define multiple events and/or the event reporting configuration can refer to the reporting of multiple events for AI/ML in RAN.

The first network node may (optionally) obtain from a third network node in one or more FOURTH MESSAGEs one or more event configurations together with corresponding identifier(s), e.g., event configuration identifier(s). The first network node may further obtain from a third network node in a FOURTH MESSAGE an indication which of those event configurations to apply or activate at a certain time, e.g., with immediate effect.

Similarly, the first network node can send to a second network node (or to a plurality of second network nodes) one or more FIRST MESSAGEs comprising one or more event configurations together with corresponding identifier(s). The first network node can further send to a second network node in a FIRST MESSAGE an indication which of those event configurations to apply or activate at a certain time. Before the first network node sends to the second network node the event configuration for event(s) for AI/ML in RAN, the first network node may have determined (e.g., by means of a trial-and-error process):
whether the second network node can/cannot detect the one or more events, according to the parameters comprised in the event definition configuration
   for example, if the first network node wants to configure an event to determine whether a metric on energy efficiency is below a certain threshold at the second network node, the first network node may deduce whether the second network node supports/does not support such event if it has previously requested to receive from the second network node updates on energy efficiency metrics (such as an energy efficiency score) to be used as input data for an AI/ML inference function deployed at the first network node, and it has determined that such information can/cannot be retrieved from the second network node
whether the second network node can/cannot provide the information to be included in an event report, and/or whether the second network node can/cannot provide such information in the way that is requested (e.g., for a certain group of UEs, for a certain time interval), according to the event reporting configuration
   for example, the first network node may deduce whether the second network node can send an event report comprising energy efficiency metrics to be used as feedback of a network energy saving action, if it has previously requested the second network node to send updates on energy efficiency metrics (such as an energy efficiency score) to be used as input for an AI/ML inference function deployed at the first network node, and it has determined that such information can/cannot be retrieved from the second network node

In the case that the first network node had not determined the above previously, it may still send the request to the second network node in a FIRST MESSAGE. The second network node can indicate in a SECOND MESSAGE whether it rejects or accepts the event configuration and/or indicate whether it accepts to send the requested event report(s). The second network node can also indicate in a SECOND MESSAGE which report(s) it can provide. The second network node can also indicate in a SECOND MESSAGE if it will be able to provide the report at a later time and/or for the same or a different configuration than the configuration in the FIRST MESSAGE.

The second network node can include in a SECOND MESSAGE one or more event configuration identifiers, e.g., in case it received multiple event configurations from the first network node, the second network node may indicate which of the event configurations it rejects or accepts using the corresponding identifiers.

In one embodiment, the FIRST MESSAGE containing the event configuration is present and the SECOND MESSAGE is not present. The first network node may assume that the second network node received the message and that it will, if supported, identify the defined events and report the requested information accordingly.

The SECOND MESSAGE enables the first network node to determine (e.g., via trial-and-error) whether the second network node can or cannot detect the one or more events, according to the event definition configuration, and whether the second network node can or cannot provide the information to be included in an event report, and/or whether the second network node can or cannot provide such information in the way that is requested, according to the event reporting configuration, as described above.

### First Aspect of AI/ML Event Reporting-Both Event Configuration and Event Report in Non-Opaque Format

In a first aspect of the disclosure, the first network node sends in a FIRST MESSAGE a request to the second network node to obtain event reports for AI/ML in RAN, and the event configuration is carried over the signaling interface in a non-opaque way. Note that an information signaled as opaque can be encoded as an OCTET string, or as bit string, or encrypted, or masked, so that its content is not understandable over the interface, whereas an information signaled as non-opaque implies that the content of the information is understandable over the interface.

Within the event configuration, the non-opaque information comprises at least an identifier of an event (e.g., an Event-ID), used to identify the event.

In one option, an event identifier itself uniquely identifies a specific event.

In one subvariant, an event identifier is obtained as a combination (e.g., a concatenation, in any order) of an event-specific identity (e.g., a progressive number) and additional identities that can be used to set the scope of an event, such as: a PLMN Identifier, a cell identifier, a Tracking Area Identifier, an identifier of private network, a node identifier (e.g., a gNB-ID), a transaction identifier, an identifier of the UE, or group of UEs, an identifier of an AI/ML model and/or an AI/ML use case.

In another option, a specific event is not uniquely identified by an event identifier alone, but instead by a combination (e.g., a concatenation, in any order) of an event identifier and additional identities that can be used to set the scope of an event, as mentioned above.

The event configuration can comprise parameters as indicated herein below (event definition configuration and event reporting configuration), e.g., one or more thresholds and/or timers to be used for event detection, timers to indicate when to start and/or when to stop sending the event reports.

In this first aspect, the second network node sends to the first network node event report(s) for AI/ML in RAN in one or more THIRD MESSAGEs, and the event report(s) is (are) sent in a non-opaque way.

An event report can comprise the same identifier of an event (e.g., an Event-ID), used to identify the event in the FIRST MESSAGE. The first network node can use an event identifier received in the event reports to match the information comprised in the event report to an event previously configured.

In another example, the event report comprises the identifier of an event plus some extra indications/identities to identify the specific second network node in case of event reports that can be received from a plurality of second nodes. It might also be the case that the plurality of second network nodes is grouped into smaller groups based on some different characteristics. For instance: the second network nodes can be comprised in a certain geographical area or a certain Tracking Area, belonging to a certain RNA (RAN Notification Area), being used in a specific role (MN or SN) in multi-connectivity operation, pertaining to a certain Radio Access Technology, operating in shared spectrum, supporting multicast/broadcast operation.

### In Some Examples of Possible Implementations:

Event configuration can be sent e.g., within an XnAP HANDOVER REQUEST message, using a new “Event Configuration for AI/ML” IE, or “Event Configuration” IE or similar;
Event report(s) can be sent e.g., with an XnAP HANDOVER REPORT message, using a new “Event Report for AI/ML” IE, or “Event Report” IE, or similar; and
Event configuration can be sent using a procedure that uses non-UE associated signaling. In one option, the configuration is sent as part of a procedure triggered by an AI/ML related action, e.g., an XnAP CELL ACTIVATION REQUEST, or MOBILITY CHANGE REQUEST message, using a new “Event Report for AI/ML” IE, or “Event Report” IE, or similar.

The second network node can include in a THIRD MESSAGE one or more event configuration identifiers, e.g., when sending to the first network node event report(s) for AI/ML in RAN in order to indicate which of the event report(s) corresponds to which of the event configurations.

The first network node may include in a FIRST MESSAGE to a second network node a request for the second network node to include in a THIRD MESSAGE one or more event configuration identifiers (or, alternatively or additionally, the corresponding event configuration as such), e.g., when sending to the first network node event report(s) for AI/ML in RAN for the above purpose.

### Second Aspect of AI/ML Event Reporting-Both Event Configuration and Event Report Partly in Non-Opaque Format

In a second aspect of the disclosure, the first network node sends in a FIRST MESSAGE a request to the second network node to obtain event reports for AI/ML in RAN, and a portion of the event configuration is carried over the signaling interface in an opaque way and another portion of the configuration is carried over in a non-opaque way. For example, a portion of the event configuration is comprised in an Information Element specified to carry at last part of the configuration of an event for AI/ML and such Information Element is encoded as an OCTET string, or as bit string, or encrypted, or masked.

The part of the event configuration that is signaled in a non-opaque way includes at least an identity of an event (e.g., an Event-ID), with the characteristics as described above for the first aspect.

The remaining part of the event configuration can comprise parameters in an event definition configuration and event reporting configuration, and its content can be signaled in a non-opaque manner or in an opaque manner.

For example, some thresholds values that the second network node can use for detecting the fulfillment of an event, and/or a reporting periodicity the second network node can use to determine how frequently it needs to send the event reports can be signaled openly, and certain configuration parameters related to conditions to be fulfilled for reporting certain metrics can be signaled in an opaque way.

In this second aspect, the second network node sends event reports for AI/ML in RAN to the first network node in one or more THIRD MESSAGEs, according to the event reporting configuration, and the information comprised in the event report is partially carried over the signaling interface in an opaque way and partially in a non-opaque way. The event reports may be encoded using the same/different format or using the same/different encryption or masking techniques as the event configuration carried in the FIRST MESSAGE. For example, a portion of the event report(s) is (are) comprised in an Information Element specified to carry at last part of the event report(s) for AI/ML and such Information Element is encoded as an OCTET string, or as bit string, or encrypted, or masked.

### In Some Examples of Possible Implementations:

At least a portion of the event configuration signaled as opaque information, can be conveyed by reusing the Mobility Information IE included in the XnAP HANDOVER REQUEST message. At least a portion of the event configuration signaled as either opaque or non-opaque information can be carried via new Information Elements e.g., an “Event Configuration for AI/ML” IE, or “Event Configuration” IE or similar; or

At least a portion of the event reporting signaled as opaque information, can be conveyed by reusing the Mobility Information IE included in the XnAP HANDOVER REPORT message, or via a new IE (e.g., an “Event Report for AI/ML” IE, or “Event Report” IE, or similar). At least a portion of the event reporting signaled as either opaque or non-opaque information can be carried via new Information Elements e.g., an “Event Report for AI/ML” IE, or “Event Report” IE or similar.

### Third Aspect of AI/ML Event Reporting-Both Event Configuration and Event Report in Opaque Format

In a third aspect of the disclosure, the first network node sends in a FIRST MESSAGE a request to the second network node to obtain event reports for AI/ML in RAN, and the event configuration is carried over the signaling interface in an opaque way. For example, the event configuration is signaled via a dedicated Information Element whose name and/or purpose is specified to carry the configuration of an event for AI/ML and the Information Element is encoded as an OCTET string, or as bit string, or encrypted, or masked. Similarly, event report(s) is (are) signaled via a dedicated Information Element whose name and/or purpose is specified to carry the report(s) of an event for AI/ML and the Information Element is encoded as an OCTET string, or as bit string, or encrypted, or masked.

In this third aspect, upon fulfillment of an event, the second network node sends event reports for AI/ML in RAN to the first network node in one or more THIRD MESSAGES according to the event reporting configuration, and the reported information is carried over the signaling interface(s) in an unspecified (opaque) way. The event reports may be encoded using the same/different format or using the same/different encryption or masking techniques as the event configuration carried in the FIRST MESSAGE.

### In Examples of Possible Implementations:

The event configuration is sent by reusing the Mobility Information IE included in the XnAP HANDOVER REQUEST message, or via a new IE (e.g., an “Event Configuration for AI/ML” IE, or “Event Configuration” IE, or similar) sent from the first network node to the second network node; or

The event reporting is sent by reusing the Mobility Information IE included in the XnAP HANDOVER REPORT message, or via a new IE (e.g., an “Event Report for AI/ML” IE, or “Event Report” IE, or similar) sent from the second network node to the first network node.

### Additional Aspects of AI/ML Event Reporting

In additional aspects, different combinations are possible according to which one or more of the event definition configurations, the event reporting configuration, and the event reports can be sent as non-opaque information (partly or fully) or not. For example:

In one aspect the event configuration is sent in an opaque format, and the event report is sent in non-opaque format; or

In one aspect the event configuration is sent in non-opaque format, and the event report is sent in opaque format.

In other variations, at least a portion of the event configuration (or at least a portion of the event definition configuration and/or the event reporting configuration) is hardcoded.

In one case, the only signaled part of an event configuration can be the Event identifier, and the remaining content of the event configuration is specified/predetermined.

### Aspects of AI/ML Event Reporting Related to Network Nodes Involved in Signaling Information Related to Events.

The following network node level aspects may be combined with each other and/or with the previous aspects concerning the information transfer described above.

### Fourth Aspect of AI/ML Event Reporting-Common Event Configuration Provided by Third Network Node in Advance

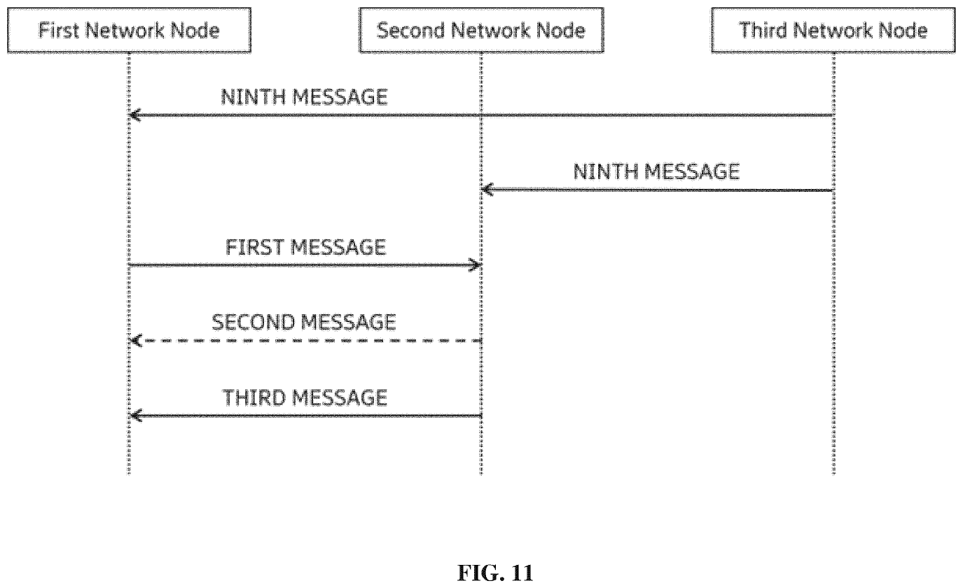

In a fourth aspect of the disclosure, both first network node and/or second network node (or a plurality of second network nodes) obtain from a third network node, e.g., an OAM or SMO, in a NINTH MESSAGE at least part of an event configuration (i.e., at least part of an event definition configuration and/or at least part of an event reporting configuration). This means that the first network node and the second network node obtain from a third network node at least a common event configuration (which may be a full or part of an event configuration). FIG. 11 illustrates a signaling diagram of the fourth aspect of the invention.

The third network node can send to both the first network node and the second network node one or more NINTH MESSAGEs comprising one or more common event configurations together with corresponding identifier(s), e.g., event configuration identifier(s), for the common event configuration(s). The third network node can further send to both the first network node and the second network node in a NINTH MESSAGE an indication which of those event configurations to apply or activate at a certain time.

The third network node can further indicate to both the first network node and the second network node in a NINTH MESSAGE that an event configuration is a common event configuration, e.g., by means of the corresponding event configuration identifier. In one embodiment, an event configuration identifier as such may indicate that an event configuration is a common event configuration.

In one example, the NINTH MESSAGE (sent from the third network node to the first network node) is the FOURTH MESSAGE, e.g., if the common event configuration is a full event configuration.

In one example, both the first network node and the second network node obtain from the third network node a common event definition configuration, so that they have a common understanding about the defined/relevant events along with the corresponding event identifiers.

In this aspect, the first network node may send to the second network node (or to a plurality of second network nodes) a FIRST MESSAGE comprising only a part (e.g., remaining part) of the event configuration of an event for AI/ML in RAN, thus complementing the common part of the event configuration obtained previously. As one option, the first network node requests the inclusion in the reports of the information described in the common part of the event configuration.

In one example, wherein both the first network node and the second network node already obtained from a third network node a common event configuration, the first network node may send to the second network node a FIRST MESSAGE comprising only an event reporting configuration with the corresponding event ID, requesting the second network node(s) to report to the first network node, or the third network node, or a fourth network node event reports for AI/ML in RAN according to the event reporting configuration.

In another example, the first network node may send to the second network node (or to a plurality of second network nodes) a FIRST MESSAGE comprising at least part of an event configuration overwriting or redefining a common event configuration obtained previously.

In another example, the first network node may indicate in the FIRST MESSAGE the identifier of an event assigned by the third network node plus some extra indications/identities to uniquely refer to the new event configuration that is at least partially based on the common event configuration. The first network node does not overwrite the common event configuration but creates a new variant of it. This is necessary to avoid misalignment between the network nodes related to the one or more defined event configurations. The first network node may include in the FIRST MESSAGE an event configuration identifier for the new event configuration that is partially based on the common event configuration. The second network node may maintain multiple parallel event configurations based on the same common event configuration (each of the resulting event configurations uniquely identified by an event configuration identifier.

In one related example, the first network node may indicate to the second network node (e.g., via a flag) in the FIRST MESSAGE that the provided event configuration is overwriting or redefining a common event configuration obtained previously, i.e., the provided event configuration is to be seen as a delta configuration and to be applied on top of the common event configuration. In one related embodiment, the first network node may send a request to the second network node in the FIRST MESSAGE to reset the event configuration that has been overwritten or redefined to the initial common event configuration obtained previously by the third network node.

In one example, wherein both the first network node and the second network node already obtained from the third network node a common event configuration, the first network node may send to the second network node a FIRST MESSAGE comprising only a part of an event reporting configuration, e.g., in order to specify explicitly for which events data reporting is being requested at a certain time.

In another embodiment, the third network node may include in the NINTH MESSAGE indications of parts of the common event configuration which can/shall or cannot/shall not be overwritten or redefined by a delta configuration described above.

In another embodiment, the second network node indicates the common event configuration in the SECOND MESSAGE or the THIRD MESSAGE, to ensure that the event configuration is aligned between the two nodes.

One or more of the NINTH MESSAGE, FIRST MESSAGE, SECOND MESSAGE, and THIRD MESSAGE can comprise one or more event configuration identifier(s) as disclosed above. This can serve the purpose of aligning the network nodes with respect to a common understanding of which event(s) is (are) defined or being configured, and for which reporting is activated/ongoing.

In another example, the third network node can send in the NINTH MESSAGE a list of one or more event configurations to the first and second network nodes. Each configuration may be identified by an event configuration identifier. The first network node may activate one particular event configuration by signaling its event configuration identifier in the FIRST MESSAGE or it may change the active event configuration via said signaling.

One advantage of this aspect is that the common part of the event configuration does not need to be signaled from the first network nodes to one or more second network nodes each time the first network node wants to request information related to events for AI/ML in RAN from the one or more second network nodes. This means that the (delta) part of the event configuration (sent from the first network node to one or more second network nodes) may comprise much less information, thereby significantly reducing the signaling overhead on the interface between the first and the one or more second network nodes.

Another advantage of this aspect is that the third network node can control or influence or support the definition of the event configuration used for requesting and reporting information related to events for AI/ML in RAN.

### Fifth Aspect of AI/ML Event Reporting—Reporting Towards a Fourth Network Node

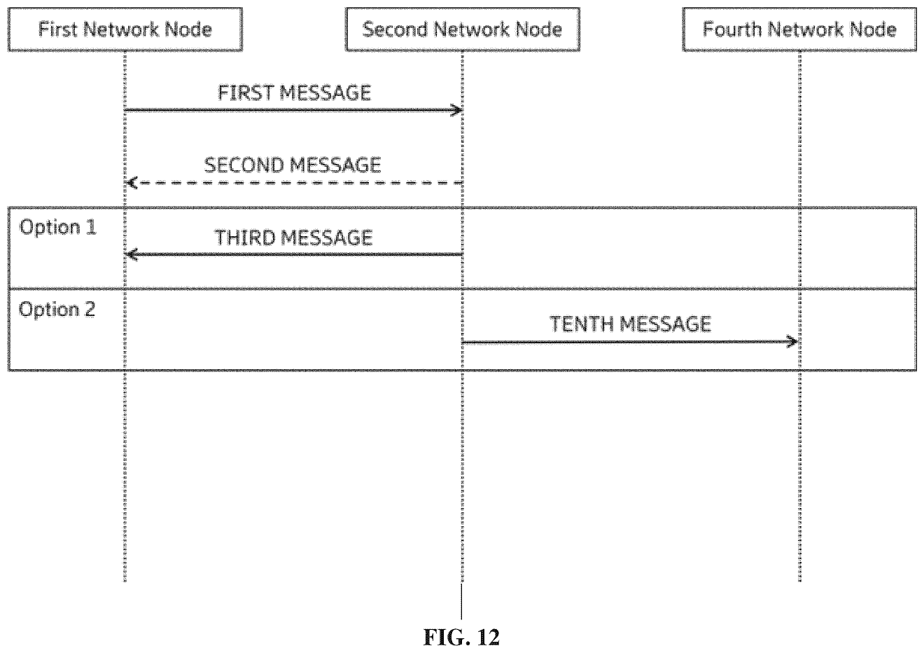

In a fifth aspect of the disclosure, the event reporting configuration indicates to the second network node (or to a plurality of second network nodes) that the event reports for AI/ML in RAN (i.e., information associated to the event for AI/ML in RAN) should be signaled to a fourth network node, instead of or in addition to the first network node. This is shown in FIG. 12, where the event reports are signaled in the THIRD MESSAGE and/or the TENTH MESSAGE.

In one example, the fourth network node is the third network node described in other aspects of the disclosure.

In another example, related to the fourth variant, the third network node signals a common event configuration to both the first and second network nodes in a NINTH MESSAGE; the common event configuration contains the address or location of the fourth network node where the event reports should be signaled. The first network node can signal in the FIRST MESSAGE that the event reports should also be signaled to itself. In this case, the second network node would transmit the event reports in both the THIRD MESSAGE (to the first network node) and the TENTH MESSAGE (to the fourth network node).

In one example, the event reporting configuration provides different configurations depending on the node receiving the report, i.e., the first or fourth network node. For example, the second network node should send a one-time report to the first network node but a periodic reporting to the fourth network node.

### Sixth Aspect of AI/ML Event Reporting—Third Network Node Provides Assistance Information for Assembling Event Configuration

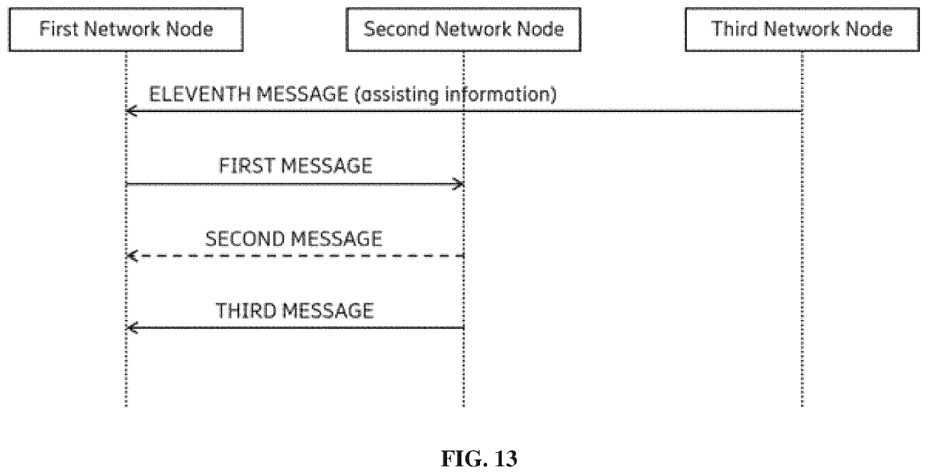

In a sixth aspect of the disclosure, the event configuration (in its aspects of event definition configuration and/or event reporting configuration) is determined/assembled by the first network node, provided that some assistance information is communicated to the first network node by a third network node. For example, the first network node can determine the configuration of an event for AI/ML, to request a second network node to provide a certain information X, provided that the third network node has informed the first network node that the second network node is able to provide to the first network node the concerned information. Note that the ability of the second network node to provide the concerned information can be direct (i.e., the second network node is able to produce the information requested by the first network node and send it to the first network node) or indirect (i.e., the second network node is able to request and obtain, for example from a UE, or yet another network node, the information requested by the first network node). This is shown in FIG. 13. The ELEVENTH MESSAGE, providing assisting information to the first network node can be also the FOURTH MESSAGE.

### Seventh Aspect of AI/ML Event Reporting—Both Event Configuration and Event Report Distributed Via a Third Network Node

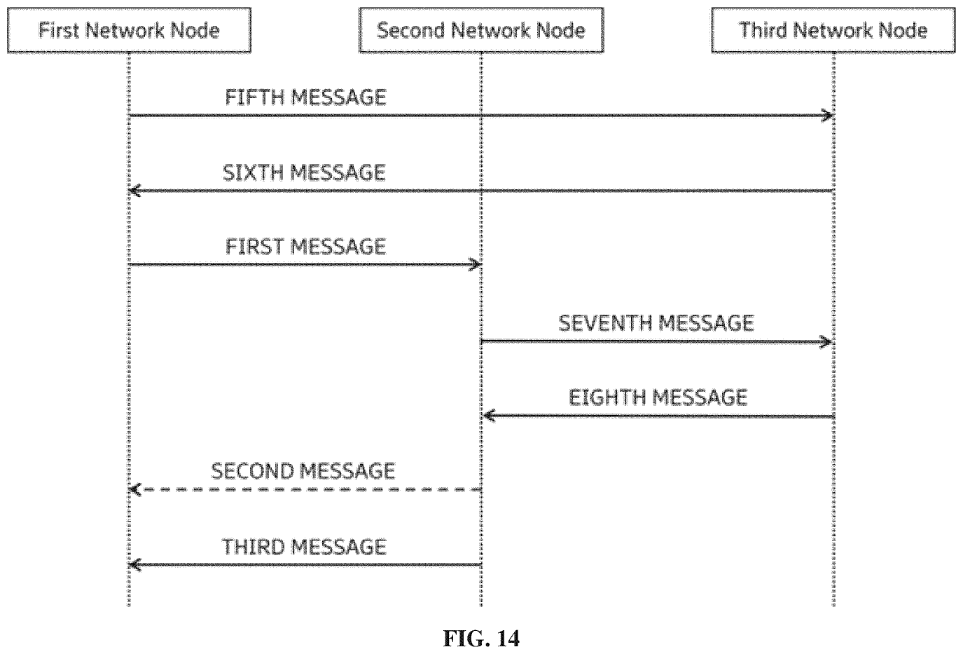

In a seventh aspect of the disclosure, the first network node sends in a FIFTH MESSAGE to a third network node the event description (e.g., a human and/or machine-readable description of the event to be used for assembling the actual event configuration). The third network node, based on this information and other additional information it may have, assembles one or more events with one or more Event-IDs, event definition configuration, and event reporting configuration. The third network node sends back to the first network node one or more Event-IDs of the assembled event(s) in a SIXTH MESSAGE. FIG. 14 illustrates a signaling diagram of the eighth aspect of the disclosure.

In one case of this aspect, the third network node may include in the SIXTH MESSAGE a list of network nodes to which the first network node should sent the event(s) reporting request(s). The assistance information needed by the first network node for sending the request(s) to these network nodes such as, e.g., an identity of the network node, an IP Address, an URI, FQDN, shall be also included in the SIXTH MESSAGE by the third network node.

Upon receiving one or more Event-ID from the third network node, the first network node sends in a FIRST MESSAGE a request to the second network node to obtain event reports for AI/ML in RAN, the FIRST MESSAGE containing the one or more Event-ID and assistance information for the second network node to contact the third network node (e.g., an identity of the third network node, an IP Address, an URI, FQDN).

Upon receiving the FIRST MESSAGE from the first network node, the second network node sends in a SEVENTH MESSAGE a request to the third network node to retrieve the event definition configuration and the event reporting configuration for the one or more events identified by the one or more Event-IDs received from the first network node. The third network node then sends in an EIGHTH MESSAGE to the second network node the event configuration (including the event definition configuration and the event reporting configuration for event information reporting to the first network node).

In one case of this aspect, the third network node may include in the event reporting configuration a list of network nodes towards which the reporting should be provided (in addition to the first network node), together with information on how to reach them (e.g., connection assistance information, such as IP Address, or URI.

After receiving the event(s) configuration from the third network node, the second network node may accept/reject the reporting request via a SECOND MESSAGE sent to the first network node.

If the reporting request is accepted and once the configured event(s) is/are triggered, the second network node starts sending event reports for AI/ML in RAN to the first network node in a THIRD MESSAGE.

### DEFINITION OF EVENTS FOR AI/ML IN RAN

An event configuration comprises an event definition configuration (identifiers, parameters, indications, and conditions to be used for determining the fulfillment of the event(s), and an event reporting configuration (parameters indicating which information is to be reported, when, and how). The event configuration can be identified by its own identifier (e.g., an event configuration identifier) and can be signaled in any of the messages described in this disclosure.

### Event Definition Configuration (EDC)

An event definition configuration of one or more events for AI/ML in RAN is a set of identifiers, and/or parameters, and/or indications, and/or actions, and/or conditions that the second network node(s) can use to determine whether a certain event for AI/ML in RAN is fulfilled.

For example, an event definition configuration of one or more events for AI/ML in RAN can be defined indicating one condition applied to a single parameter (e.g., to a metric or to an action).

In one example, an event for AI/ML in RAN “high predicted average number of connected users” can be defined/identified based on the metric “predicted average number of connected user” and applying the condition “is above a threshold”.

In another example, an event for AI/ML in RAN “handover determined/assisted by AI/ML” can be defined/identified based on the condition that the inference function of an AI/ML model has determined to initiate a handover. The event “handover determined/assisted by AI/ML” in this case can be identified for example by a reason (a cause value) indicating that the action “handover” is initiated based on the condition that “an AI/ML inference function has determined/assisted RAN in triggering the handover”. Similar reasoning can apply to conditional handover, or DAPS handover.

In more general terms, an event definition configuration can be defined based on a plurality of conditions applied to a plurality of parameters (metrics, actions, procedures, indexes, notifications).

The event definition configuration of one or more events for AI/ML in RAN comprises one or more of:
1) one or more identifiers of the one or more events;
2) indications of observed metrics, predicted metrics, executed actions, predicted/planned actions, aborted/reverted actions, radio procedures, notifications, indexes, thresholds, timers, state transitions, locations, for each of the event(s) to be used for detecting fulfillment of the event(s);
3) conditions applied to observed metrics, predicted metrics, executed actions, predicted/planned actions, aborted/reverted actions, radio procedures, notifications, indexes, thresholds, timers, state transitions, locations, for each of the event(s) for detecting that the event(s) is (are) fulfilled;
4) identities/identifiers associated to the event(s), such as: identifier(s) of the requesting node and/or involved network nodes, identifier(s) of transaction/action, identifier(s) of a UE or a group of UEs to which the event(s) pertains to, identifier(s) related to AI/ML processes such as identifiers for one or more AI/ML models (e.g., model ID or version number) and/or one more AI/ML use cases;
5) indications of scope parameters. Non-limiting examples of scope parameters include:
   objects associated to the event(s) for AI/ML in RAN. Non-limiting examples can be any combination of: a single UE, a group of UEs, one or more cells or reference beams, radio access technologies, network nodes, network functions, network slices, Tracking Areas, ARFCNs, shared spectrum channels, QoS parameters, service types, coverage states;
   radio related procedures associated to the event(s) for AI/ML in RAN. Non-limiting examples can be: a mobility procedure (handover, conditional handover, DAPS handover, change of mobility parameters), cell activation, an RRC Reconfiguration procedure, an RRC resume procedure, an RRC release procedure, one of the procedures related to multi-connectivity operation as described in 3GPP TS 37.340 such as: Secondary Node Addition, Conditional PSCell Addition, Secondary Node Modification (MN/SN initiated), Secondary Node Release (MN/SN initiated), Secondary Node Change (MN/SN initiated), PSCell change, Inter-Master Node handover with/without Secondary Node change, Master Node to eNB/gNB Change, eNB/gNB to Master Node change; and
   actions initiated/ongoing at the first network node and/or at the second network node, or executed/terminated by the first network node and/or at the second network node. Non-limiting examples can be: an energy saving actions initiated by the first network node, e.g., cell deactivation, reduction of DL transmit power, etc., a coverage update initiated/planned/performed by the first network node (e.g., in relation to Coverage and Capacity Optimization).
6) An indication of whether and how multiple events should be grouped together to constitute an overall event, for which fulfilment implies the fulfilment of each event included in the event group.
   In this example, each event may be defined as per the details specified in other embodiments above such as conditions on observed metrics, e.g., an event may be associated to one or more specific metric and to one or more threshold per metric. Fulfilment of a single event implies fulfilment of the conditions on the observed metrics, e.g. the one or more metric measured needs to be above the threshold associated to the metric. Fulfilment of the overall event resulting from grouping single events together results from the fulfilment of each single event.
   One example of how this embodiment could be achieved is shown in the tables below

### AI-ML Assistance Data Request

This message is sent by NG-RAN node₁ to NG-RAN node₂ to initiate the requested assistance data reporting in support to AI/ML functions, according to the parameters given in the message.
Direction: NG-RAN node₁® NG-RAN node₂

| IE/Group | | | IE type & | Semantics | | Assigned |
|---|---|---|---|---|---|---|
| Name | Presence | Range | reference | description | Criticality | Criticality |
| Message Type | M | | 9.2.3.1 | | YES | reject |
| NG-RAN | M | | INTEGER | Allocated by NG-RAN | YES | reject |
| node1 | | | (1 . . . | node₁ | | |
| Measurement | | | 4095, . . .) | | | |
| ID | | | | | | |
| NG-RAN | C- | | INTEGER | Allocated by NG-RAN | YES | ignore |
| node2 | ifRegistra- | | (1 . . . | node₂ | | |
| Measurement | tionRequestStoporAdd | | 4095, . . .) | | | |
| ID | | | | | | |
| Registration | M | | ENUMERATED(start, | Type of request for | YES | reject |
| Request | | | stop, | which the assistance | | |
| | | | add, . . .) | data is required. | | |
| Report | C- | | BITSTRING | Each position in the | YES | reject |
| Characteristics | ifRegistra- | | (SIZE(128)) | bitmap indicates | | |
| | tionRequestStart | | | measurement object | | |
| | | | | the NG-RAN node 2 is | | |
| | | | | requested to report. | | |
| | | | | First Bit = Predicted | | |
| | | | | Radio Resources | | |
| | | | | Periodic, | | |
| | | | | Second Bit = Current | | |
| | | | | Energy Efficiency | | |
| | | | | Periodic, | | |
| | | | | Third Bit = Predicted | | |
| | | | | Energy Efficiency | | |
| | | | | Periodic, | | |
| | | | | Fourth Bit = UE | | |
| | | | | Performance Indicator. | | |
| | | | | Other bits shall be | | |
| | | | | ignored by the NG- | | |
| | | | | RAN node 2. | | |
| Cell To | | 0 . . . 1 | | Cell ID list to which the | YES | ignore |
| Report List | | | | request applies. | | |
| >Cell To | | 1 . . . | | | — | |
| Report Item | | <maxnoofCellsinNG- | | | | |
| | | RANnode> | | | | |
| >>Cell ID | M | | Global NG- | | — | |
| | | | RAN Cell | | | |
| | | | Identity | | | |
| | | | 9.2.2.27 | | | |
| Reporting | O | | ENUMERATED(500 ms, | Periodicity that can be | YES | ignore |
| Periodicity | | | 1000 ms, | used for reporting. | | |
| | | | 2000 ms, | | | |
| | | | 5000 ms, | | | |
| | | | 10000 ms, | | | |
| | | | . . .) | | | |
| Event List | | 0 . . . 1 | | List of events upon | YES | ignore |
| | | | | which the requested | | |
| | | | | information is reported. | | |
| >Events To | | 1 . . . | | | — | |
| Report Item | | <maxnoofEvents> | | | | |
| >>Event | M | | 9.2.2.xx | | — | |
| Configuration | | | | | | |

### Event Configuration

This IE provides the configuration of events upon which information reporting is triggered.

| IE/Group | | | IE type & | | IE/Group | |
|---|---|---|---|---|---|---|
| Name | Presence | Range | reference | Semantics description | Name | Presence |
| Event Group | | 0 . . . 1 | | List of events forming | YES | ignore |
| List | | | | the final event upon | | |
| | | | | which information | | |
| | | | | reporting is triggered, if | | |
| | | | | the final event is fulfilled. | | |
| >Events To | | 1 . . . | | | — | |
| Group Item | | <maxnoofEvents> | | | | |
| >>Event ID | M | | BITSTRING | | — | |
| | | | (SIZE(128)) | | | |
| >Metrics | O | | 9.2.2.YY | Describes the conditions | — | |
| Conditions | | | | on metrics that | | |
| | | | | determine if an event is | | |
| | | | | fulfilled | | |

### Metrics Conditions

This IE provides the configuration of metrics conditions upon which information an event is fulfilled.

| | | | | | | |
|---|---|---|---|---|---|---|
| IE/Group | | | IE type & | | IE/Group | |
| Name | Presence | Range | reference | Semantics description | Name | Presence |

| | | | | |
|---|---|---|---|---|
| Predicted Radio | O | 9.2.2.zz | Conditions on predicted | — |
| Resource Status | | | value of the Radio | |
| Conditions | | | Resource Status IE | |
| Predicted TNL | O | 9.2.2.zz | Conditions on predicted | — |
| Capacity Indicator | | | value of the TNL | |
| Conditions | | | Capacity Indicator IE | |
| Predicted Composite | O | 9.2.2.zz | Conditions on predicted | — |
| Available Capacity | | | value of the Composite | |
| Group Conditions | | | Available Capacity | |
| | | | Group IE | |
| Predicted Slice | O | 9.2.2.zz | Conditions on predicted | — |
| Available Capacity | | | value of the Slice | |
| Conditions | | | Available Capacity IE | |
| Predicted Number of | O | 9.2.2.zz | Conditions on predicted | — |
| Active UEs | | | value of the Number of | |
| Conditions | | | Active UEs IE | |
| Predicted RRC | O | 9.2.2.zz | Conditions on predicted | — |
| Connections | | | value of the RRC | |
| Conditions | | | Connections IE | |
| Predicted Energy | O | 9.2.2.zz | Conditions on Predicted | |
| Efficiency | | | value of the Energy | |
| | | | Efficiency IE | |
| Radio Resource | O | 9.2.2.zz | Conditions on Measured | — |
| Status Conditions | | | value of the Radio | |
| | | | Resource Status IE | |
| TNL Capacity | O | 9.2.2.zz | Conditions on Measured | — |
| Indicator Conditions | | | value of the TNL | |
| | | | Capacity Indicator IE | |
| Composite Available | O | 9.2.2.zz | Conditions on Measured | — |
| Capacity Group | | | value of the Composite | |
| Conditions | | | Available Capacity | |
| | | | Group IE | |
| Slice Available | O | 9.2.2.zz | Conditions on Measured | — |
| Capacity Conditions | | | value of the Slice | |
| | | | Available Capacity IE | |
| Number of Active UEs | O | 9.2.2.zz | Conditions on Measured | — |
| Conditions | | | value of the Number of | |
| | | | Active UEs IE | |
| RRC Connections | O | 9.2.2.zz | Conditions on Measured | — |
| Conditions | | | value of the RRC | |
| | | | Connections IE | |
| Energy Efficiency | O | 9.2.2.zz | Conditions on Measured | |
| | | | value of the Energy | |
| | | | Efficiency IE | |
| UE Throughput DL | O | 9.2.2.zz | Conditions on Measured | |
| | | | value of Throughput DL | |
| UE Throughput UL | O | 9.2.2.zz | Conditions on Measured | |
| | | | value of UE Throughput | |
| | | | UL | |
| Packet Delay | O | 9.2.2.zz | Conditions on Measured | |
| | | | value of Packet Delay | |
| Packet Error Rate | O | 9.2.2.zz | Conditions on Measured | |
| | | | value of Packet Error | |
| | | | Rate | |
| RAN Visible QoE | O | 9.2.2.zz | Conditions on Measured | |
| | | | value of RAN Visible | |
| | | | QoE | |

### Conditions Information

This IE provides description of the conditions a metric shall fulfil

| | | | | | | |
|---|---|---|---|---|---|---|
| IE/Group | | | IE type & | Semantics | IE/Group | |
| Name | Presence | Range | reference | description | Name | Presence |

| | | | |
|---|---|---|---|
| Metric | M | INTEGER | The condition is |
| Threshold | | (0 . . . | fulfilled if the metric |
| Low | | 4,000,000,000,000, | is above this |
| | | . . . ) | threshold |
| Metric | M | INTEGER | The condition is |
| Threshold | | (0 . . . | fulfilled if the metric |
| High | | 4,000,000,000,000, | is above this |
| | | . . . ) | threshold |
| Accuracy | O | INTEGER | The condition is |
| Threshold | | (0 . . . 100) | fulfilled if the |
| | | | accuracy is above |
| | | | this threshold |
| Validity Time | O | INTEGER | The condition is |
| Threshold | | (0 . . . 4095) | fulfilled if the validity |
| | | | time is above this |
| | | | threshold. |

In the above example, the Event Configuration IE is used to configure an event made of one or more events, where each event may be associated to event conditions.

Events are, in this example, identified with Event IDs, where an Event ID consists of a pointer value to a preconfigured event. However, this should not be interpreted as a limiting conditions. Events can be identified in any of the possible ways described in this disclosure.

The examples above represent events conditions as Metrics Conditions, where the metrics shown are made of predicted and measured metrics. The conditions have been represented as thresholds, namely a high and a low threshold, where the condition is fulfilled if the metric is above the high threshold value or below the low threshold value. It should be noted that the threshold has been shown as an integer. The value of the threshold in this example would have to adapt to the specific metric, e.g., if the threshold applies to the Composite Available Capacity Group, the Threshold values would need to be within a 0 to 100 range. It is possible also to define dedicated thresholds (with dedicated threshold value ranges) for each of the metrics for which conditions need to be defined.

The Metrics Conditions can apply also to aspects that are specific for predictions, such as a prediction accuracy and a prediction validity time.

An event may be fulfilled if the metrics associated to this events that constitute predictions have an accuracy and a validity time within well-defined limits, such as an accuracy higher than a threshold and a validity time higher than a certain time threshold.

Such conditions may apply together with other conditions on the same metrics (predictions and non-predictions). For example, a condition may consist of a predicted metric being above a certain threshold and the prediction accuracy being above a given threshold and the prediction validity time being above a given threshold. At the same time the event may be fulfilled if conditions on other measured metrics apply, e.g., a measured metric is below a given threshold.

### Event Reporting Configuration (ERC)

An event reporting configuration of one or more events for AI/ML in RAN is a set of identifiers, parameters, indications, and/or conditions signaled from a first network node to one (or more) second network node(s) that the second network node(s) can use to assemble the report(s) of events for AI/ML in RAN and determine when and where to send such report(s).

The event report configuration of one or more events for AI/ML in RAN specifies one or more of:
1) indications of events for which data reporting is being requested, e.g., a list of event identifiers as per event definition configuration;
2) content of an event report (information associated to events for AI/ML in RAN);
3) indications of when an event report is to be sent and/or when it is not to be sent;
4) indications of how and where an event report is to be sent, e.g., to the first network node or a fourth network node;
5) indications related to the priority of conditions, e.g., weights, defining (or triggering) the event reporting (e.g., if there are multiple conditions that are to be satisfied to trigger the event reporting. For example, an event is determined by three different conditions, with associated weights 2, 1, and 1. The event is reported when the sum of the fulfilled conditions is equal or larger than a certain weight threshold; in this example, the threshold is assumed to be 2. Therefore, if at least the first condition is fulfilled, or if at least both the second and third conditions are fulfilled, then the event reporting is triggered;
6) indications related to the priority of events, e.g., weights, to report in case multiple events are configured. For example, in case multiple events are defined/configured and two or more of those events occur simultaneously or at similar/close time instants, if a second network node cannot report all the requested information, e.g., if a second network node cannot collect and/or process all the requested information, a second network node may choose what information to report according to the event priorities or weights;
7) In case there is a plurality of second nodes, and they are grouped in smaller groups according to some characteristic, there might be different conditions about when to send the report;
8) In case an update of the event reporting configuration is sent, this can be specified either as a full configuration or as a delta (i.e., only signaling the differences between the old and new configuration). In one option, the first network node may refer to the new updated configuration using the same event ID with additional identifier/indication. The later would uniquely identify the new configuration that is partially based on a previous configuration;
9) An indication of whether and how multiple events should be grouped together to constitute an overall event, for which fulfilment implies the fulfilment of each event included in the event group. The same description applied to the multiple event grouping above applies.

An event reporting configuration can indicate that sending of event report(s) can occur according to any combination of the following criteria
if the network node requested to send the report supports all the information to be reported
if the network node requested to send the report supports at least part of the information to be reported
only once
periodically, according to one periodicity (e.g., according to a reporting period)
periodically, according to different periodicities, e.g.,
   different metrics at different periodicities, or
   initially at a first periodicity, followed by a second periodicity after a certain amount of time or after a timer has expired, or after collecting a certain amount of samples, or
   different periodicities according to which conditions were fulfilled or not fulfilled, or
   different periodicities for different network nodes receiving the reports
only upon (any or significant) change in the reported information since the latest report (e.g., more than a threshold X, or more than a percentage Y)
periodically, however, the node requested to report may skip the reporting occasion, for example as long as the information to be reported does not vary significantly (e.g., not more than a threshold X, or not more than a percentage Y) as compared to the previously reported information
until a timer expires
until a maximum amount of event reports is reached
until a maximum amount of data is reached/collected
only for the first UE, or first X number of UEs
when a certain number of samples is collected
when a certain number of events occurred
together with certain UE reports (e.g., together with SHR, or with SPR, or with RVQoE report)
from a certain start time
until a certain stop/end time
within a certain time interval (from start time to stop time)
for only one UE
for a group of UEs
for all UEs
per network node (e.g. metrics or performance at node level granularity)
per cell, or reference signal, or frequency layer, or MIMO layer, or RAT
per network slice(s)
for certain service types
for certain metrics or performance(s) (e.g., UL or DL throughput, UL or DL delay, PRB utilization, number of RRC connected users, etc.)
for certain actions (e.g., for handover whose triggering has been determined/assisted by AI/ML, for multi-connectivity operations, for resume)
for certain action identifiers
as long as the condition defining at least one event is valid
until an updated event reporting configuration is sent, either as a full configuration or as a delta to the current one
as long as the conditions determining the fulfillment of the event are met

In one example, an event reporting configuration can indicate to report for a single UE the DL throughput for a time interval of 5 seconds starting from handover completion.

In another example, an event reporting configuration can indicate to report the energy efficiency of the target network node after the handover is completed for at least 5 UEs.

In another example, an event reporting configuration can indicate to report the DL throughput for one or more UEs after handover completion with an initial reporting period (say e.g., 200 ms), and after 10 event reports are sent, continue sending event reports until a certain maximum number of event reports are reached (say MAX_EVENT_REPORTS) with a different reporting period (e.g., 2 sec).

### Information Associated to an Event for AI/ML in RAN can be

feedback identifier, associated to one or more actions determined/recommended by an AI/ML model inference function, or associated to an AI/ML based prediction determined by an AI/ML model inference function, whether the one or more actions are/were executed, planned/predicted, aborted/reverted
load metrics, measured/predicted metrics, energy efficiency/energy savings metrics, measured UE trajectory, predicted UE trajectory, radio related performance, application layer performance
interruption time, RVQoE metrics

### Examples of Events for AI/ML in RAN

As non-limiting examples of events for AI/ML in RAN, these can pertain to: mobility, multi-connectivity, energy savings, location information. Some examples of events and details of event reporting configuration for each one of the above are provided below.

### Mobility

Some non-limiting examples of events for AI/ML in RAN related to mobility are:
intra-frequency or inter-frequency handover
handover of a single UE or a group of UEs for a specific handover cause,
availability of RLF report, successful HO report, RA report, or MHI from one or more UEs,
predicted UE trajectory different than observed UE trajectory,
conditional handover
LTM (L1/L2-Triggered Mobility)
Metrics concerning the performance of UEs at the target cell after HO being higher/lower than specified per metric thresholds
Metrics concerning the resource status of one or more specific cells being higher/lower than specified per metric thresholds
a combination thereof.

An event reporting configuration of one or more events for AI/ML in RAN related to mobility can comprise
(what to report) indications of information to be reported:
   one or more performance metrics: DL/UL throughput, interruption time in user plane, RVQoE metrics collected post-handover completion or during handover execution, number of visited cells, identities of visited cells, number of visited reference signal beams, identities of reference signal beams, dwelling time in the cell(s)/reference signal beams, UE geographical location, time of releasing a UE to RRC_INACTIVE or RRC_IDLE
      some examples of granularity: only one UE, a cell, a number of UEs (e.g., according to a maximum value indicated in the event definition configuration), a group of UEs (the group being identified according to an identifier included in the event definition configuration)
   subsequent events or procedures occurring after handover. Non-limiting examples can be:
      subsequent handover is attempted after a certain amount of time after handover completion,
      release of a UE (or a certain number of UEs) to RRC_INACTIVE or RRC_IDLE after a certain amount of time after handover completion
      addition (or removal) for a UE (or a certain number of UEs) of at least one cell as PSCell or SCell
      reconfiguration from single connectivity to multi-connectivity after a certain amount of time after handover completion
(when and how to report) indications of when to collect information to be reported, or when to report, or for how long to report:
   from a “start time” to an “end time”
      start time: the time of handover completion, an offset from the time of handover completion, the time of initiating the handover execution at the UE, an offset from the time of initiating the handover execution at the UE, the time of reception of handover command from the first network node
      “end time”: a number of reporting periods after the “start time”, a number of event reports after the “start time”
   until an “end time” (“start time” can be implicit or specified, e.g., from the time of handover completion)
   until a certain number of event reports are sent
   not before a certain time has passed from the handover preparation/execution/completion
   when subsequent action (e.g. a subsequent handover) has occurred, optionally upon condition that it occur within a maximum time interval

### Multi-Connectivity

Some non-limiting examples of events for AI/ML in RAN related to multi-connectivity are:
SCell addition/modification/release,
SCG activation/deactivation,
CPAC (Conditional PSCell Addition/Change).
Metrics concerning the performance of UEs at the SCG and/or at the one or more SCell being higher/lower than specified per metric thresholds
Metrics concerning the resource status of one or more specific cells used as SCG and/or SCell being higher/lower than specified per metric thresholds
a combination thereof.

An event reporting configuration of one or more events for AI/ML in RAN related to multi-connectivity can comprise
(what) indications of information to be reported:
   one or more performance metrics: DL/UL throughput in at least one of the network nodes comprised in the multi-connectivity operation (e.g., the SN node in case of SN Addition)
(when) indications of when to collect information to be reported, or when to report, or for how long to report:
   from a “start time” to an “end time”
      start time: the time of completion of a multi-connectivity related procedure, an offset from the time of completion of the multi-connectivity operation, the time at which a network node sends an updated radio configuration is sent to the UE, an offset from the time at which a network node sends an updated radio configuration to the UE
      “end time”: a number of reporting periods after the “start time”, a number of event reports after the “start time”
   until an “end time” (“start time” can be implicit or specified, e.g., from the time of completion of a multi-connectivity related procedure)
   until a certain number of event reports are sent
   not before a certain time has passed from the initiation/completion of a multi-connectivity related procedure

### Multi-Connectivity

Some non-limiting examples of events for AI/ML in RAN related to energy savings are:
cell activation/deactivation
modification of DL transmit power
observed or predicted energy consumption during a certain time interval being above or below a certain threshold
observed energy consumption during a certain time interval being (significantly) different from the predicted energy consumption
predicted energy consumption during a certain time interval being (significantly) different from the previous prediction of energy consumption for the same time interval
Metrics concerning the performance of UEs at the target cell after HO being higher/lower than specified per metric thresholds
Metrics concerning the resource status of one or more specific cells being higher/lower than specified per metric thresholds

An event reporting configuration of one or more events for AI/ML in RAN related to energy saving can comprise:
(what) indications of information to be reported:
   one or more performance metrics: DL/UL throughput for a UE, the number of UEs affected by an energy saving action initiated by the first network node (e.g., number of UEs released to RRC_IDLE, of the number of UEs offloaded from the first network node to the second network node), energy consumption/efficiency metric (e.g., energy consumption/efficiency score) for the second network node(s)
(when) indications of when to collect information to be reported, or when to report, or for how long to report:
   not before a certain time has passed from the initiation/completion/modification of an energy saving related procedure
   when a variation in the energy consumption is observed by the second node

### Location

Some non-limiting examples of events for AI/ML in RAN related to location are:
predicted UE trajectory different than observed UE trajectory,
predicted best beam different than observed best beam,
predicted best carrier frequency different than observed best carrier frequency,
predicted time of staying in a certain cell or a certain reference beam different than observed by more than a value
predicted time of UE remaining in a certain RRC state while being served by or camped on a certain cell or a certain reference beam different than observed by more than a value
predicted amount of RRC state transitions while being served by or camped on a certain cell or a certain reference beam different than observed by more than a value
predicted RAN Notification Area different than observed/measured
a combination thereof.

An event reporting configuration of one or more events for AI/ML in RAN related to location can comprise:
(what) indications of information to be reported:
   one or more metrics: UE History Information, UE trajectory, frequency information (e.g. ARFCN) of the carriers visited by the UE, number of UEs visiting a certain cell or a certain reference signal beams, number of UEs visiting a certain Tracking Area, percentage of handed over UEs for which a certain cell is listed in UE History Information (optionally within a certain time interval), number of UEs released to RRC_INACTIVE or RRC_IDLE while visiting a certain cell
      some examples of granularity: only one UE, a number of UEs (e.g., according to a maximum value indicated in the event definition configuration), a group of UEs (the group being identified according to an identifier included in the event definition configuration)

### Applicability of the Methods

Regarding possible scenarios of applicability of the methods, some non-limiting examples are provided below:
the first network node and/or the second network node can be different RAN nodes (e.g. two gNBs, or two eNBs, or two en-gNBs, or two ng-eNBs)
the first network node and/or the second network node can be different nodes/functions of a same RAN node (e.g. a gNB-CU-CP and a gNB-DU, or a gNB-CU-CP and a gNB-CU-UP)
the first network node can be a RAN node and the second network node can be a UE
the first network node can be a RAN node (e.g. a gNBs, or a eNBs, or a en-gNBs, or a ng-eNBs) and the second network node can be a component/functions of a second RAN node (e.g. gNB-CU-CP)
the first network node and/or the second network node can pertain to the same Radio Access Technology (e.g. e.g. E-UTRAN, NG-RAN, WiFi, etc.) or to different Radio Access Technologies (e.g. one to NR and the other to E-UTRAN or WiFi)
the first network node and/or the second network node can pertain to the same RAN system (e.g. E-UTRAN, NG-RAN, WiFi, etc) or to different RAN systems (e.g. one to NG-RAN and the other to E-UTRAN)
the first network node and the second network node may be connected via a direct signaling connection (e.g. two gNB via XnAP), or an indirect signaling connection (e.g. an e-NB and a gNB via S1AP, NGAP and one or more Core Network nodes, e.g. an MME and an AMF)
the first network node can be a management system, such as the OAM system or the SMO, while the second network node can consist of a RAN node or function.
the first network node can be a core network node or function, such a 5GC function, while the second network node can consist of a RAN node or function.

### Methods and Apparatuses

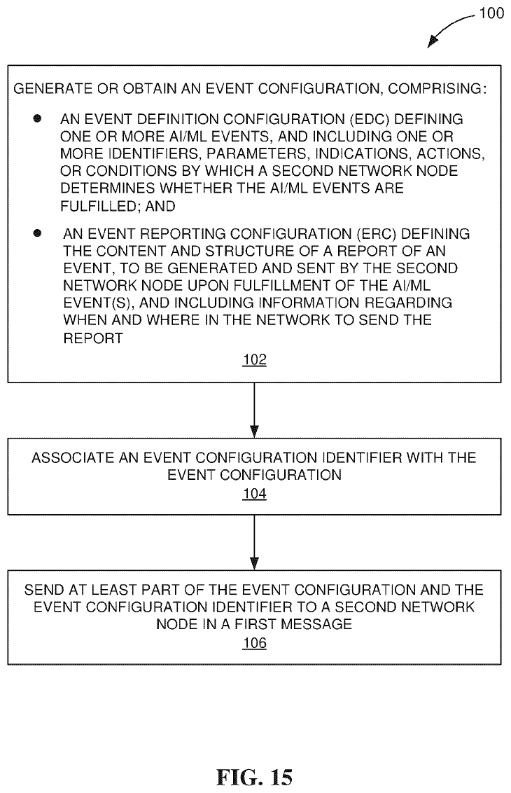

FIG. 15 depicts a method 100, performed by a first network node, of ascertaining information related to Artificial Intelligence (AI) or Machine Learning (ML) in a wireless communication network. An event configuration is generated or obtained (e.g., in whole or part from a third node) (block 102). The event configuration comprises an event definition configuration (EDC) defining one or more AI/ML events, and including one or more identifiers, parameters, indications, actions, or conditions by which a second network node determines whether the AI/ML events are fulfilled. The event configuration further comprises an event reporting configuration (ERC) defining the content and structure of a report of an event, to be generated and sent by the second network node upon fulfillment of the AI/ML event(s), and including information regarding when and where in the network to send the report. An event configuration identifier is associated with the event configuration (block 104). At least part of the event configuration and the event configuration identifier are sent to a second network node in a first message (block 106).

In general, any of the network nodes of the wireless communication network discussed herein may comprise dedicated network equipment, such as a base station (e.g., eNB, gNB), one or more Network Functions (e.g., UPF, PCF) implemented as a dedicated network node or using general purpose computational resources such as a data center, or a fixed or mobile terminal such as a User Equipment (UE), IoT device, or the like. In general, any such network node may implement functionality ascribed herein to the first node, second node, or the like.

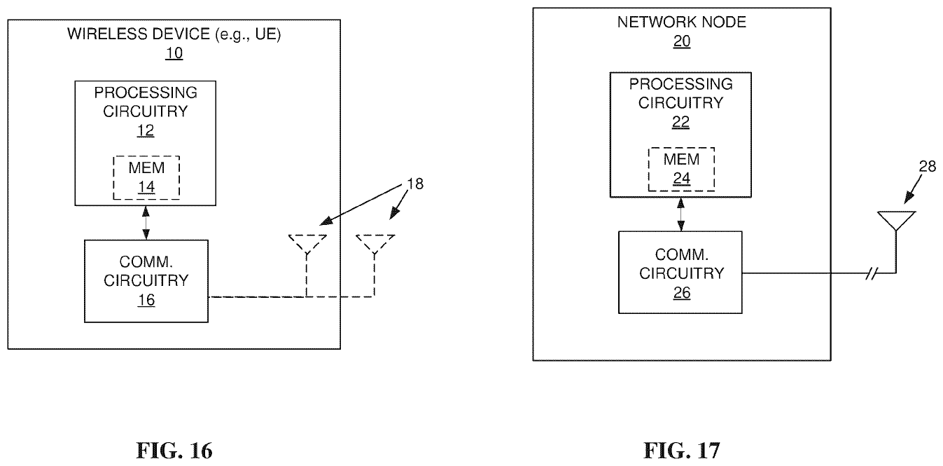

FIG. 16 depicts a wireless device 10, such as a UE, operative in a wireless communication network and configured to request (first network node) or measure and report (second network node) or otherwise participate (third, fourth network node) in AI/ML event monitoring and reporting as described herein. As used herein, a UE 10 is any type of device capable of communicating with a base station, another UE 10, or other network node, over radio signals. A UE 10 may therefore refer to a cellphone or smartphone, a machine-to-machine (M2M) device, a machine-type communications (MTC) device, a Narrowband Internet of Things (NB IoT) device, etc. Despite its name, a UE 10 does not necessarily have a “user” in the sense of an individual person owning and/or operating the device. A UE 10 may also be referred to as a radio device, a radio communication device, a wireless communication device, a wireless terminal, or simply a terminal-unless the context indicates otherwise, the use of any of these terms is intended to include device-to-device UEs or devices, machine-type devices, or devices capable of machine-to-machine communication, sensors equipped with a radio network device, wireless-enabled table computers, mobile terminals, smart phones, laptop-embedded equipped (LEE), laptop-mounted equipment (LME), USB dongles, wireless customer-premises equipment (CPE), etc. In the discussion herein, the terms machine-to-machine (M2M) device, machine-type communication (MTC) device, wireless sensor, and sensor may also be used. It should be understood that these devices may be UEs 10, but may be configured to transmit and/or receive data without direct human interaction.

The UE 10 includes processing circuitry 12, memory 14, and communication circuitry 16. The processing circuitry 12 is configured to perform methods according to aspects described herein, such as by executing software code stored in memory 14. The processing circuitry 12 is operatively connected to communication circuitry 16, which includes radio circuits, such a Radio Frequency (RF) transceiver connected to one or more antennas 18, to effect wireless communication across an air interface to one or more base stations, access points, or other UEs 10. As indicated by the dashed lines, the antenna(s) 18 may protrude externally from the UE 10, or the antenna(s) 18 may be internal. In some aspects, the UE 10 includes a user interface (not shown), which may include features such as a display, touchscreen, keyboard or keypad, microphone, speaker, and the like). In some embodiments, such as in many M2M, MTC, or NB IoT scenarios, the UE 10 may include only a minimal, or no, user interface.

FIG. 17 depicts a network node 20 operative in the wireless communication network and configured to request (first network node) or measure and report (second network node) or otherwise participate (third, fourth network node) in AI/ML event monitoring and reporting as described herein. In some aspects, the network node 20 may be a base station providing wireless communication services to one or more UEs 10 in a geographic region (known as a cell or sector). The network node 20 includes processing circuitry 22, memory 24, and communication circuitry 26. The processing circuitry 12 is configured to perform methods according to aspects described herein, such as by executing software code stored in memory 14. The processing circuitry 12 is operatively connected to communication circuitry 16, which at a minimum includes circuitry configured to communicate with other network nodes, such as by a wired or wireless interface. In the case that the network node 20 implements a base station, it additionally includes radio circuits, such as an RF transceiver, and is connected to one or more antennas 28, to effect wireless communication across an air interface to one or more UEs. As indicated by the continuation lines in the antenna feed line of FIG. 16, the antenna(s) 54 may be physically located separately from the base station 20, such as mounted on a tower, building, or the like.

In all aspects described herein, the processing circuitry 12, 22 may comprise any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above. Although depicted as being contained in the wireless device 10 or network node 20, the processing circuitry 12, 22 may in some aspects be located remotely. In some aspects, the processing circuitry 12, 22 may comprise virtualized servers located at one or more data centers, commonly referred to as the “cloud.” The blocks 12, 22 labeled “processing circuitry” include memory 14, 24, as well as other circuitry, such as power control circuitry, co-processors, dedicated hardware (en/decryption, graphics processing, user interface control), and the like.

In all embodiments described herein, the memory 14, 24 may comprise any nontransitory machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like.

In all embodiments described herein, the communication circuits 16, 26 may comprise a transceiver interface used to communicate with one or more other nodes over a communication network according to one or more communication protocols known in the art or that may be developed, such as Ethernet, TCP/IP, SONET, ATM, or the like. The UE communication circuits 16, and in the case the network node 20 implements a base station, the communication circuits 26 implement RF transceiver functionality appropriate to the wireless communication network links (e.g., RF signaling conforming to 3GPP specifications, Wi-Fi, or the like).

### Advantages of Aspects of the Present Disclosure

One advantage of aspect of the present disclosure is to enable efficient reporting of feedback information associated to an action type or a specific action instance indicated by the first network node, so as to reduce signaling overhead. The disclosure has also the advantage of enabling efficient conclusion of inter-node communication procedure when reporting feedback information associated to actions, e.g., as derived via an AI/ML algorithm (or when feedback is associated to an AI/ML based/assisted use case, or when feedback is associated to an AI/ML model).

Another advantage of the methods described herein is to provide efficient means to determine and provide only relevant feedback information, thereby avoiding signaling feedback information that may no longer be relevant for the purpose it was originally requested.

Yet another advantage of the methods described herein is to enable efficient feedback information initialization, configuration, and reporting between two network node when two distinct signaling procedures are used to initialize, request or configure the feedback information reporting procedure and to actual report the requested feedback information, respectively.

The methods described herein enable an AI/ML algorithm to retrieve information that can serve as feedback on the performance of an IA/ML model or on the quality of AI/ML derived inferences. With that, the AI/ML algorithm is able to evaluate whether AI/ML models need to be modified, e.g., need to be retrained. Alternatively, the information can be used to determine whether different algorithms need to be adopted to derive the actions and decisions otherwise relying on AI/ML inference. For example, based on feedback it could be decided not to use the specific AI/ML algorithm for which the feedback is given and instead use other non AI/ML based techniques.

An advantage of the more general event reporting solution is to enable collection of event-based feedback to support AI/ML based predictions and/or actions in RAN. Such a mechanism allows for a drastic reduction of data exchanged for AI/ML support purposes.

This is because data collected are filtered according to the fulfilment conditions for the defined events. A reduction of information exchange produces a number of advantages such as:
Reduction of traffic load over interfaces, avoiding congestions, and performance drops
Reduction of information to be processed and stored by nodes involved in data collection
Retrieval of information that are needed for AI/ML model optimization, e.g., feedback data or training data, that enable improvements of the AI/ML model via e.g., re-training

Aspects of the present disclosure differentiate from legacy event-based feedback reporting in that the definition of the events is related to the nature of AI/ML processes and algorithms in RAN. For example, an event may be defined as “the predicted energy consumption during a certain time interval given by AI/ML model A is (significantly) different from the one predicted by AI/ML model B, while both predictions are of high confidence (or low uncertainty)”.

1.-26. (canceled)

27. A method, performed by a first network node, of ascertaining information related to Artificial Intelligence (AI) or Machine Learning (ML) in a wireless communication network, the method comprising:
generating or obtaining an event configuration, comprising
an event definition configuration (EDC) defining one or more AI/ML events, and including one or more identifiers, parameters, indications, actions, or conditions by which a second network node determines whether the AI/ML events are fulfilled; and
an event reporting configuration (ERC) defining the content and structure of a report of an event, to be generated and sent by the second network node upon fulfillment of the AI/ML event(s), and including information regarding when and where in the network to send the report;
associating an event configuration identifier with the event configuration; and
sending at least part of the event configuration and the event configuration identifier to a second network node in a first message.

28. The method of claim 27, wherein the first message includes two or more event configurations and associated event configuration identifiers and an indication of which event configuration to apply at a defined time.

29. The method of claim 27, further comprising, prior to sending the first message to the second network node:
ascertaining that the second node can detect the AI/ML event(s) per the EDC; and
ascertaining that the second node can report the AI/ML event(s) per the ERC.

30. The method of claim 27, further comprising receiving from the second network node a second message indicating, for one or more event configurations in the first message, whether the second network node:
rejects the event configuration(s);
accepts the event configuration(s); or
accepts the event configuration(s) with specified modifications to the ERC.

31. The method of claim 27, further comprising:
receiving, from the second network node, a third message including a report of one or more AI/ML events as defined by the EDC, the report conforming to the ERC.

32. The method of claim 31, further comprising:
prior to sending the first message, receiving, from a third network node, a fourth message including one or more event configurations, each associated with an event configuration identifier, optionally, wherein the fourth message further includes an indication of which event configuration to send to the second network node at a defined time.

33. The method of claim 27, further comprising, prior to sending the first message:
receiving, from a third network node, a ninth message including at least part of an EDC or at least part of an ERC of an event configuration and a corresponding event configuration identifier, which at least partial event configuration is also sent to the second node, whereby the first and second network nodes have a common at least partial event configuration.

34. The method of claim 33 wherein the ninth message includes one or more of:
an indication of which event configuration to apply at a defined time;
an indication of that the event configuration is common to two or more nodes;
a complete EDC; and
an indication of which parts of the event configuration shall not be modified;

35. The method of claim 33 wherein the first message
omits one or more part of the event configuration that are common;
comprises only a complete or partial ERC;
updates or overrides one or more part of the event configuration that are common.

36. The method of claim 27, wherein the ERC in an event configuration in the first message directs the second network node to send AI/ML event results to a fourth network node.

37. The method of claim 27 further comprising, prior to sending the first message:
receiving event configuration assistance information from a third network node.

38. The method of claim 27 further comprising, prior to sending the first message:
sending, to a third network node, a fifth message including a description of an AI/ML event;
receiving, from the third network node, a sixth message including one or more event identifiers; and
wherein the first message includes one or more event identifiers and assistance information allowing the second network node to obtain event configurations for the event identifiers from the third network node.

39. The method of claim 27 wherein:
both the EDC and ERC of an event configuration in the first message are sent in a non-opaque format; or
part of both the EDC and ERC of an event configuration in the first message are sent in a non-opaque format, and part of both the EDC and ERC are sent in an opaque format; or
both the EDC and ERC of an event configuration in the first message are sent in an opaque format.

40. The method of claim 27 wherein the EDC comprises one or more conditions applied to one or more metrics, actions, or network/radio procedures.

41. The method of claim 27 wherein the ERC specifies that a report is sent:
when requested;
only once;
periodically;
only upon a change in reported information in excess of a threshold amount;
until a timer expires; or
for a defined duration.

42. The method of claim 27 wherein the ERC specifies that a report is sent:
when a predefined number of events occurred;
when a predefined number of samples are collected;
for predefined metrics;
for predefined network actions;
per network node, cell, radio access technology (RAT), or slice;
for one, a predefined group, or all user equipment (UE);

43. The method of claim 31 wherein the EDC of one or more event configurations in the first message includes an identifier of an action instance or action type undertaken by the first network node, further wherein the third message includes information related to the specified action instance or action type.

44. The method of claim 43 wherein the first and third messages are sent as:
part of the same network procedure; or
parts of two network procedures,
further wherein:
one procedure is specific for AI/ML and one procedure is not specific for AI/ML;
or
neither of the two procedures is specific for AI/ML.

45. An apparatus, operative in a wireless communication network implementing Artificial Intelligence (AI) or Machine Learning (ML) characterized by:
communication circuitry configured to communicate with one or more network nodes; and
processing circuitry operatively connected to the communication circuitry, the processing circuitry configured to:
generate or obtain an event configuration, comprising
an event definition configuration (EDC) defining one or more AI/ML events, and including one or more identifiers, parameters, indications, actions, or conditions by which a second network node determines whether the AI/ML events are fulfilled; and
an event reporting configuration (ERC) defining the content and structure of a report of an event, to be generated and sent by the second network node upon fulfillment of the AI/ML event(s), and including information regarding when and where in the network to send the report;
associate an event configuration identifier with the event configuration; and
send at least part of the event configuration and the event configuration identifier to a second network node in a first message.

46. The apparatus of claim 45, wherein the apparatus is one of:
a network node in the wireless communication network; and
a User Equipment operative in the wireless communication network.
